(19) United States
(12) Patent Application Publication
(10) Pub. No.: US 2023/0192141 A1
(43) Pub. Date: Jun. 22, 2023

(54) MACHINE LEARNING TO DETECT AND ADDRESS DOOR PROTRUDING FROM VEHICLE

(71) Applicant: GM CRUISE HOLDINGS LLC, San Francisco, CA (US)

(72) Inventors: Yi Zhang, Belmont, CA (US); Ankit Raj, San Bruno, CA (US); Nicolay Postarnakevich, San Francisco, CA (US); Torehan Sharman, San Francisco, CA (US); Qiuhua Lin, Foster City, CA (US); Ruxiao Bao, San Jose, CA (US); Xiao Zhang, Los Altos, CA (US); Wudao Ling, San Francisco, CA (US)

(21) Appl. No.: 17/552,971

(22) Filed: Dec. 16, 2021

(51) Int. Cl. B60W 60/00; G06T 7/70; G06N 20/00; B60J 5/04

(52) U.S. Cl. CPC B60W 60/0024; B60W 60/0017; B60W 60/0027; G06T 7/70; G06N 20/00; B60J 5/04; B60W 2420/42; B60W 2420/52; G06T 2207/30252; G06T 2207/10028

(57) ABSTRACT

Environmental tracking systems and methods are disclosed. An environmental tracking system receives sensor data from the one or more sensors, such as camera(s) and Light Detection and Ranging (LIDAR) sensors. The system uses trained machine learning (ML) model(s) to detect, within the sensor data, representation(s) of at least a portion of a vehicle with a door that is at least partially open. Based on these representation(s), the system generates a boundary for the vehicle that includes the door and is sized based on the door being at least partially open. The system determines a route that avoids the boundary, for example by planning the route around the boundary or by planning to stop before intersecting with the boundary. In some examples, the sensors are sensors coupled to a second vehicle, and the second vehicle traverses the route.

### TECHNICAL FIELD

The present technology generally pertains to analysis of sensor data captured by one or more sensors that are used by a vehicle. More specifically, the present technology pertains to detection of a door protruding from another vehicle in the environment within the sensor data, and routing of the vehicle based on the detected door.

### BACKGROUND

Autonomous vehicles (AVs) are vehicles having computers and control systems that perform driving and navigation tasks that are conventionally performed by a human driver. As AV technologies continue to advance, a real-world simulation for AV testing has been critical in improving the safety and efficiency of AV driving.

An AV may encounter other vehicles as it drives through an environment. In some cases, one of these other vehicles in the environment around the AV may change shape. For instance, in some cases, a door may open or close for one of these other vehicles in the environment, changing the shape of the vehicle. Changes to the shape of a vehicle in the environment, for instance due to one or more doors of the vehicle opening or closing, may increase the risk of an AV colliding with the vehicle. Furthermore, in some cases, one or more pedestrians may emerge from such a vehicle or approach such a vehicle, increase the risk of an AV colliding with pedestrians.

### BRIEF DESCRIPTION OF THE DRAWINGS

The advantages and features of the present technology will become apparent by reference to specific implementations illustrated in the appended drawings. A person of ordinary skill in the art will understand that these drawings only show some examples of the present technology and would not limit the scope of the present technology to these examples. Furthermore, the skilled artisan will appreciate the principles of the present technology as described and explained with additional specificity and detail through the use of the accompanying drawings in which:

FIG. 1 illustrates an example of a system for managing one or more autonomous vehicles (AVs) in accordance with some aspects of the present technology;

FIG. 2A is a conceptual diagram illustrating top-down views of a bounding box for a vehicle that changes due to detection of a door of the vehicle opening, in accordance with some aspects of the present technology;

FIG. 2B is a conceptual diagram illustrating perspective views of a bounding box for a vehicle that changes due to detection of a door of the vehicle opening, in accordance with some aspects of the present technology;

FIG. 3 is a block diagram illustrating an environment analysis and routing system, in accordance with some aspects of the present technology;

FIG. 4 is a block diagram illustrating an environment analysis system, in accordance with some aspects of the present technology;

FIG. 5 is a conceptual diagram illustrating fusion of an image and a point cloud, in accordance with some aspects of the present technology;

FIG. 6 is a conceptual diagram illustrating rerouting of an autonomous vehicle from a first planned route to a second planned route in response to a change in a bounding box for a vehicle due to detection of a door of the vehicle opening, in accordance with some aspects of the present technology;

FIG. 7 is a block diagram illustrating a range-based environment analysis system, in accordance with some aspects of the present technology;

FIG. 8 is a block diagram illustrating an example of a neural network that can be used for environment analysis, in accordance with some examples;

FIG. 9 is a graph illustrating respective perception levels for different types of environment analysis systems, in accordance with some examples;

FIG. 10 is a graph illustrating respective precision-recall curves for different types of environment analysis systems, in accordance with some examples;

FIG. 11 is a flow diagram illustrating a process for environmental analysis in accordance with some examples; and

FIG. 12 shows an example of a system for implementing certain aspects of the present technology.

### DETAILED DESCRIPTION

Various examples of the present technology are discussed in detail below. While specific implementations are discussed, it should be understood that this is done for illustration purposes only. A person skilled in the relevant art will recognize that other components and configurations may be used without parting from the spirit and scope of the present technology. In some instances, well-known structures and devices are shown in block diagram form in order to facilitate describing one or more aspects. Further, it is to be understood that functionality that is described as being carried out by certain system components may be performed by more or fewer components than shown.

Autonomous vehicles (AVs) are vehicles having computers and control systems that perform driving and navigation tasks that are conventionally performed by a human driver. As AV technologies continue to advance, a real-world simulation for AV testing has been critical in improving the safety and efficiency of AV driving.

An Autonomous Vehicle (AV) is a motorized vehicle that can navigate without a human driver. An exemplary autonomous vehicle includes a plurality of sensor systems, such as, but not limited to, a camera sensor system, a Light Detection and Ranging (LIDAR) sensor system, or a Radio Detection and Ranging (RADAR) sensor system, amongst others. The autonomous vehicle operates based upon sensor signals output by the sensor systems. Specifically, the sensor signals are provided to an internal computing system in communication with the plurality of sensor systems, wherein a processor executes instructions based upon the sensor signals to control a mechanical system of the autonomous vehicle, such as a vehicle propulsion system, a braking system, or a steering system. Similar sensors may also be mounted onto non-autonomous vehicles, for example onto vehicles whose sensor data is used to generate or update street maps.

An AV may encounter other vehicles as it drives through an environment. In some cases, one of these other vehicles in the environment around the AV may change shape. For instance, in some cases, a door may open or close for one of these other vehicles in the environment, changing the shape of the vehicle based on whether or not the door protrudes from the vehicle. Changes to the shape of a vehicle in the environment, for instance due to one or more doors of the vehicle opening or closing, may increase the risk of an AV colliding with the vehicle.

Environmental tracking systems and methods are disclosed. An environmental tracking system receives sensor data from one or more sensors, such as camera(s) and Light Detection and Ranging (LIDAR) sensors. The system uses trained machine learning (ML) model(s) to detect, within the sensor data, representation(s) of at least a portion of a vehicle with a door that is at least partially open. Based on these representation(s), the system generates a boundary for the vehicle that includes the door and is sized based on the door being at least partially open. The system determines a route that avoids the boundary, for example by planning the route around the boundary or by planning to stop before intersecting with the boundary. In some examples, the sensors are sensors coupled to a second vehicle, and the second vehicle traverses the route.

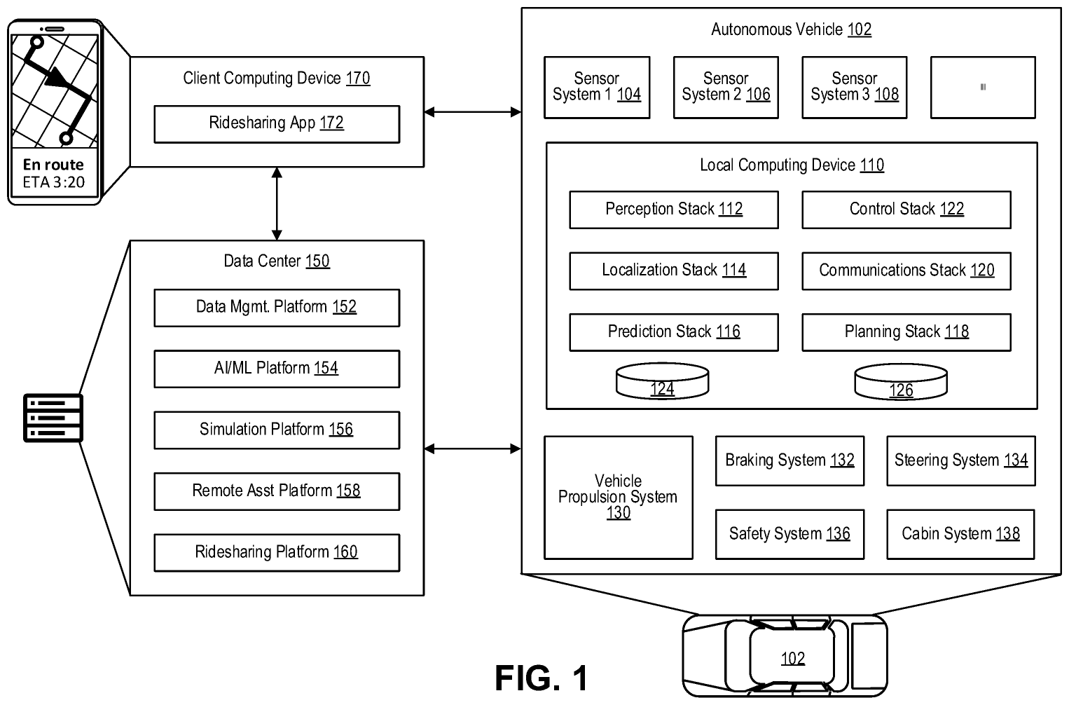

FIG. 1 illustrates an example of an Autonomous Vehicle (AV) management system 100. One of ordinary skill in the art will understand that, for the AV management system 100 and any system discussed in the present disclosure, there can be additional or fewer components in similar or alternative configurations. The illustrations and examples provided in the present disclosure are for conciseness and clarity. Other embodiments may include different numbers and/or types of elements, but one of ordinary skill the art will appreciate that such variations do not depart from the scope of the present disclosure.

In this example, the AV management system 100 includes an AV 102, a data center 150, and a client computing device 170. The AV 102, the data center 150, and the client computing device 170 can communicate with one another over one or more networks (not shown), such as a public network (e.g., the Internet, an Infrastructure as a Service (IaaS) network, a Platform as a Service (PaaS) network, a Software as a Service (SaaS) network, other Cloud Service Provider (CSP) network, etc.), a private network (e.g., a Local Area Network (LAN), a private cloud, a Virtual Private Network (VPN), etc.), and/or a hybrid network (e.g., a multi-cloud or hybrid cloud network, etc.).

The AV 102 can navigate roadways without a human driver based on sensor signals generated by multiple sensor systems 104, 106, and 108. The sensor systems 104-108 can include different types of sensors and can be arranged about the AV 102. For instance, the sensor systems 104-108 can comprise Inertial Measurement Units (IMUs), cameras (e.g., still image cameras, video cameras, etc.), light sensors (e.g., light detection and ranging (LIDAR) systems, ambient light sensors, infrared sensors, etc.), radio detection and ranging (RADAR) systems, GPS receivers, audio sensors (e.g., microphones, sound navigation and ranging (SONAR) systems, sound detection and ranging (SODAR) systems, ultrasonic sensors, etc.), microphones, time of flight (ToF) sensors, structured light sensors, engine sensors, speedometers, tachometers, odometers, altimeters, tilt sensors, impact sensors, airbag sensors, seat occupancy sensors, open/closed door sensors, tire pressure sensors, rain sensors, and so forth. For example, the sensor system 104 can be a camera system, the sensor system 106 can be a LIDAR system, and the sensor system 108 can be a RADAR system. Other embodiments may include any other number and type of sensors.

The AV 102 can also include several mechanical systems that can be used to maneuver or operate the AV 102. For instance, the mechanical systems can include a vehicle propulsion system 130, a braking system 132, a steering system 134, a safety system 136, and a cabin system 138, among other systems. The vehicle propulsion system 130 can include an electric motor, an internal combustion engine, or both. The braking system 132 can include an engine brake, brake pads, actuators, and/or any other suitable componentry configured to assist in decelerating the AV 102. The steering system 134 can include suitable componentry configured to control the direction of movement of the AV 102 during navigation. The safety system 136 can include lights and signal indicators, a parking brake, airbags, and so forth. The cabin system 138 can include cabin temperature control systems, in-cabin entertainment systems, and so forth. In some embodiments, the AV 102 might not include human driver actuators (e.g., steering wheel, handbrake, foot brake pedal, foot accelerator pedal, turn signal lever, window wipers, etc.) for controlling the AV 102. Instead, the cabin system 138 can include one or more client interfaces (e.g., Graphical User Interfaces (GUIs), Voice User Interfaces (VUIs), etc.) for controlling certain aspects of the mechanical systems 130-138.

The AV 102 can additionally include a local computing device 110 that is in communication with the sensor systems 104-108, the mechanical systems 130-138, the data center 150, and the client computing device 170, among other systems. The local computing device 110 can include one or more processors and memory, including instructions that can be executed by the one or more processors. The instructions can make up one or more software stacks or components responsible for controlling the AV 102; communicating with the data center 150, the client computing device 170, and other systems; receiving inputs from riders, passengers, and other entities within the AV's environment; logging metrics collected by the sensor systems 104-108; and so forth. In this example, the local computing device 110 includes a perception stack 112, a mapping and localization stack 114, a prediction stack 116, a planning stack 118, a communications stack 120, a control stack 122, an AV operational database 124, and an HD geospatial database 126, among other stacks and systems.

The perception stack 112 can enable the AV 102 to “see” (e.g., via cameras, LIDAR sensors, infrared sensors, etc.), “hear” (e.g., via microphones, ultrasonic sensors, RADAR, etc.), and “feel” (e.g., pressure sensors, force sensors, impact sensors, etc.) its environment using information from the sensor systems 104-108, the mapping and localization stack 114, the HD geospatial database 126, other components of the AV, and other data sources (e.g., the data center 150, the client computing device 170, third party data sources, etc.). The perception stack 112 can detect and classify objects and determine their current locations, speeds, directions, and the like. In addition, the perception stack 112 can determine the free space around the AV 102 (e.g., to maintain a safe distance from other objects, change lanes, park the AV, etc.). The perception stack 112 can also identify environmental uncertainties, such as where to look for moving objects, flag areas that may be obscured or blocked from view, and so forth. In some embodiments, an output of the prediction stack can be a bounding area around a perceived object that can be associated with a semantic label that identifies the type of object that is within the bounding area, the kinematic of the object (information about its movement), a tracked path of the object, and a description of the pose of the object (its orientation or heading, etc.).

The mapping and localization stack 114 can determine the AV's position and orientation (pose) using different methods from multiple systems (e.g., GPS, IMUs, cameras, LIDAR, RADAR, ultrasonic sensors, the HD geospatial database, etc.). For example, in some embodiments, the AV 102 can compare sensor data captured in real-time by the sensor systems 104-108 to data in the HD geospatial database 126 to determine its precise (e.g., accurate to the order of a few centimeters or less) position and orientation. The AV 102 can focus its search based on sensor data from one or more first sensor systems (e.g., GPS) by matching sensor data from one or more second sensor systems (e.g., LIDAR). If the mapping and localization information from one system is unavailable, the AV 102 can use mapping and localization information from a redundant system and/or from remote data sources.

The prediction stack 116 can receive information from the localization stack 114 and objects identified by the perception stack 112 and predict a future path for the objects. In some embodiments, the prediction stack 116 can output several likely paths that an object is predicted to take along with a probability associated with each path. For each predicted path, the prediction stack 116 can also output a range of points along the path corresponding to a predicted location of the object along the path at future time intervals along with an expected error value for each of the points that indicates a probabilistic deviation from that point.

The planning stack 118 can determine how to maneuver or operate the AV 102 safely and efficiently in its environment. For example, the planning stack 116 can receive the location, speed, and direction of the AV 102, geospatial data, data regarding objects sharing the road with the AV 102 (e.g., pedestrians, bicycles, vehicles, ambulances, buses, cable cars, trains, traffic lights, lanes, road markings, etc.) or certain events occurring during a trip (e.g., emergency vehicle blaring a siren, intersections, occluded areas, street closures for construction or street repairs, double-parked cars, etc.), traffic rules and other safety standards or practices for the road, user input, and other relevant data for directing the AV 102 from one point to another and outputs from the perception stack 112, localization stack 114, and prediction stack 116. The planning stack 118 can determine multiple sets of one or more mechanical operations that the AV 102 can perform (e.g., go straight at a specified rate of acceleration, including maintaining the same speed or decelerating; turn on the left blinker, decelerate if the AV is above a threshold range for turning, and turn left; turn on the right blinker, accelerate if the AV is stopped or below the threshold range for turning, and turn right; decelerate until completely stopped and reverse; etc.), and select the best one to meet changing road conditions and events. If something unexpected happens, the planning stack 118 can select from multiple backup plans to carry out. For example, while preparing to change lanes to turn right at an intersection, another vehicle may aggressively cut into the destination lane, making the lane change unsafe. The planning stack 118 could have already determined an alternative plan for such an event. Upon its occurrence, it could help direct the AV 102 to go around the block instead of blocking a current lane while waiting for an opening to change lanes.

The control stack 122 can manage the operation of the vehicle propulsion system 130, the braking system 132, the steering system 134, the safety system 136, and the cabin system 138. The control stack 122 can receive sensor signals from the sensor systems 104-108 as well as communicate with other stacks or components of the local computing device 110 or a remote system (e.g., the data center 150) to effectuate operation of the AV 102. For example, the control stack 122 can implement the final path or actions from the multiple paths or actions provided by the planning stack 118. This can involve turning the routes and decisions from the planning stack 118 into commands for the actuators that control the AV's steering, throttle, brake, and drive unit.

The communication stack 120 can transmit and receive signals between the various stacks and other components of the AV 102 and between the AV 102, the data center 150, the client computing device 170, and other remote systems. The communication stack 120 can enable the local computing device 110 to exchange information remotely over a network, such as through an antenna array or interface that can provide a metropolitan WIFI network connection, a mobile or cellular network connection (e.g., Third Generation (3G), Fourth Generation (4G), Long-Term Evolution (LTE), 5th Generation (5G), etc.), and/or other wireless network connection (e.g., License Assisted Access (LAA), Citizens Broadband Radio Service (CBRS), MULTEFIRE, etc.). The communication stack 120 can also facilitate the local exchange of information, such as through a wired connection (e.g., a user's mobile computing device docked in an in-car docking station or connected via Universal Serial Bus (USB), etc.) or a local wireless connection (e.g., Wireless Local Area Network (WLAN), Bluetooth®, infrared, etc.).

The HD geospatial database 126 can store HD maps and related data of the streets upon which the AV 102 travels. In some embodiments, the HD maps and related data can comprise multiple layers, such as an areas layer, a lanes and boundaries layer, an intersections layer, a traffic controls layer, and so forth. The areas layer can include geospatial information indicating geographic areas that are drivable (e.g., roads, parking areas, shoulders, etc.) or not drivable (e.g., medians, sidewalks, buildings, etc.), drivable areas that constitute links or connections (e.g., drivable areas that form the same road) versus intersections (e.g., drivable areas where two or more roads intersect), and so on. The lanes and boundaries layer can include geospatial information of road lanes (e.g., lane centerline, lane boundaries, type of lane boundaries, etc.) and related attributes (e.g., direction of travel, speed limit, lane type, etc.). The lanes and boundaries layer can also include 3D attributes related to lanes (e.g., slope, elevation, curvature, etc.). The intersections layer can include geospatial information of intersections (e.g., crosswalks, stop lines, turning lane centerlines and/or boundaries, etc.) and related attributes (e.g., permissive, protected/permissive, or protected only left turn lanes; legal or illegal u-turn lanes; permissive or protected only right turn lanes; etc.). The traffic controls lane can include geospatial information of traffic signal lights, traffic signs, and other road objects and related attributes.

The AV operational database 124 can store raw AV data generated by the sensor systems 104-108, stacks 112-122, and other components of the AV 102 and/or data received by the AV 102 from remote systems (e.g., the data center 150, the client computing device 170, etc.). In some embodiments, the raw AV data can include HD LIDAR point cloud data, image data, RADAR data, GPS data, and other sensor data that the data center 150 can use for creating or updating AV geospatial data or for creating simulations of situations encountered by AV 102 for future testing or training of various machine learning algorithms that are incorporated in the local computing device 110.

The data center 150 can be a private cloud (e.g., an enterprise network, a co-location provider network, etc.), a public cloud (e.g., an Infrastructure as a Service (IaaS) network, a Platform as a Service (PaaS) network, a Software as a Service (SaaS) network, or other Cloud Service Provider (CSP) network), a hybrid cloud, a multi-cloud, and so forth. The data center 150 can include one or more computing devices remote to the local computing device 110 for managing a fleet of AVs and AV-related services. For example, in addition to managing the AV 102, the data center 150 may also support a ridesharing service, a delivery service, a remote/roadside assistance service, street services (e.g., street mapping, street patrol, street cleaning, street metering, parking reservation, etc.), and the like.

The data center 150 can send and receive various signals to and from the AV 102 and the client computing device 170. These signals can include sensor data captured by the sensor systems 104-108, roadside assistance requests, software updates, ridesharing pick-up and drop-off instructions, and so forth. In this example, the data center 150 includes a data management platform 152, an Artificial Intelligence/Machine Learning (AI/ML) platform 154, a simulation platform 156, a remote assistance platform 158, and a ridesharing platform 160, among other systems.

The data management platform 152 can be a “big data” system capable of receiving and transmitting data at high velocities (e.g., near real-time or real-time), processing a large variety of data and storing large volumes of data (e.g., terabytes, petabytes, or more of data). The varieties of data can include data having different structured (e.g., structured, semi-structured, unstructured, etc.), data of different types (e.g., sensor data, mechanical system data, ridesharing service, map data, audio, video, etc.), data associated with different types of data stores (e.g., relational databases, key-value stores, document databases, graph databases, column-family databases, data analytic stores, search engine databases, time series databases, object stores, file systems, etc.), data originating from different sources (e.g., AVs, enterprise systems, social networks, etc.), data having different rates of change (e.g., batch, streaming, etc.), or data having other heterogeneous characteristics. The various platforms and systems of the data center 150 can access data stored by the data management platform 152 to provide their respective services.

The AI/ML platform 154 can provide the infrastructure for training and evaluating machine learning algorithms for operating the AV 102, the simulation platform 156, the remote assistance platform 158, the ridesharing platform 160, the cartography platform 162, and other platforms and systems. Using the AI/ML platform 154, data scientists can prepare data sets from the data management platform 152; select, design, and train machine learning models; evaluate, refine, and deploy the models; maintain, monitor, and retrain the models; and so on.

The simulation platform 156 can enable testing and validation of the algorithms, machine learning models, neural networks, and other development efforts for the AV 102, the remote assistance platform 158, the ridesharing platform 160, the cartography platform 162, and other platforms and systems. The simulation platform 156 can replicate a variety of driving environments and/or reproduce real-world scenarios from data captured by the AV 102, including rendering geospatial information and road infrastructure (e.g., streets, lanes, crosswalks, traffic lights, stop signs, etc.) obtained from the cartography platform 162; modeling the behavior of other vehicles, bicycles, pedestrians, and other dynamic elements; simulating inclement weather conditions, different traffic scenarios; and so on.

The remote assistance platform 158 can generate and transmit instructions regarding the operation of the AV 102. For example, in response to an output of the AI/ML platform 154 or other system of the data center 150, the remote assistance platform 158 can prepare instructions for one or more stacks or other components of the AV 102.

The ridesharing platform 160 can interact with a customer of a ridesharing service via a ridesharing application 172 executing on the client computing device 170. The client computing device 170 can be any type of computing system, including a server, desktop computer, laptop, tablet, smartphone, smart wearable device (e.g., smartwatch, smart eyeglasses or other Head-Mounted Display (HMD), smart ear pods, or other smart in-ear, on-ear, or over-ear device, etc.), gaming system, or other general purpose computing device for accessing the ridesharing application 172. The client computing device 170 can be a customer's mobile computing device or a computing device integrated with the AV 102 (e.g., the local computing device 110). The ridesharing platform 160 can receive requests to pick up or drop off from the ridesharing application 172 and dispatch the AV 102 for the trip.

In some examples, the AV 102 includes one or more computing systems 1200, and/or one or more components thereof. In some examples, the local computing device 110 includes one or more computing systems 1200, and/or one or more components thereof. In some examples, the client computing device 170 includes one or more computing systems 1200, and/or one or more components thereof. In some examples, the data center 150 includes one or more computing systems 1200, and/or one or more components thereof.

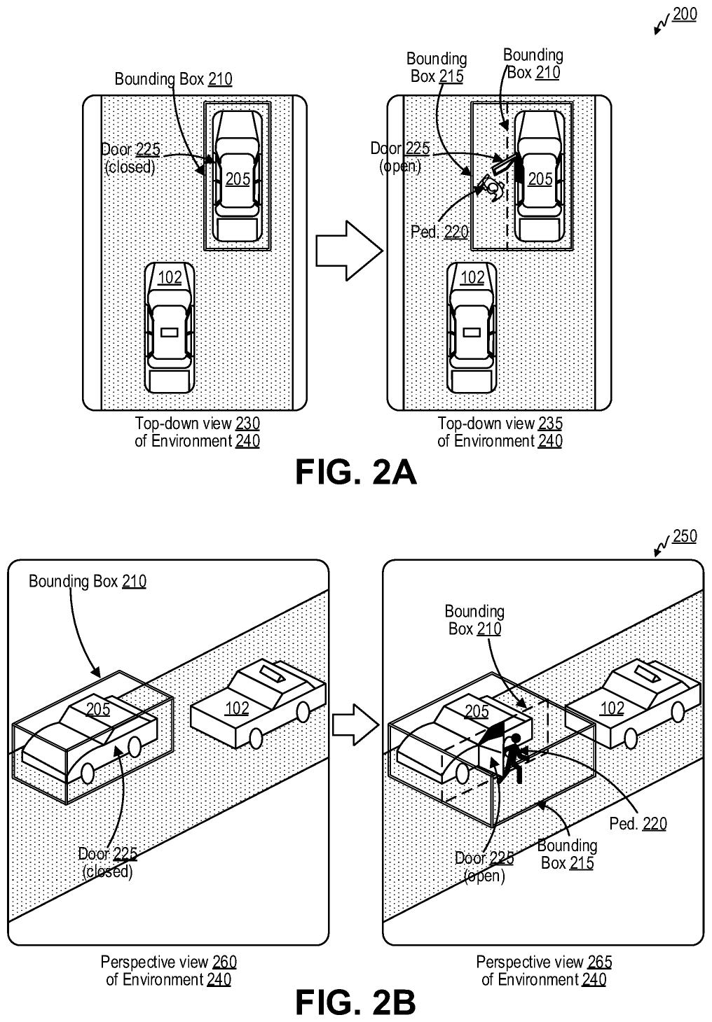

FIG. 2A is a conceptual diagram illustrating top-down views 230-235 of a bounding box for a vehicle 205 that changes due to detection of a door 225 of the vehicle 205 opening. Two top-down views 230-235 of an environment 240 are illustrated, including a top-down view 230 and a top-down view 235. The environment 240 includes the AV 102 and the vehicle 205. Within the environment 240, the vehicle 205 is in front of, and to the right of, the AV 102. In the top-down view 230, the door 225 of the vehicle 205 is closed. The state of the door 225 in the top-down view 230 may be referred to as a closed state. In the top-down view 235, the door 225 of the vehicle 205 is at least partially open and protruding from the vehicle. The state of the door 225 in the top-down view 235 may be referred to as an open state. In some examples, as indicated by the white arrow in FIG. 2A, the top-down view 235 occurs after the top-down view 230 in time, meaning that the door 225 goes from the closed state to the open state. In some examples, the top-down view 230 instead occurs after the top-down view 235 in time (the reverse of the direction indicated by the white arrow in FIG. 2A), meaning that the door 225 goes from the open state to the closed state.

A pedestrian 220 is also illustrated coming out of the vehicle 205, through a doorway corresponding to the door 225, in the top-down view 235. In some examples, the pedestrian 220 is physically present in the environment 240 at the location illustrated in the top-down view 235. In some examples, the pedestrian 220 is a simulated “shadow” pedestrian that the system(s) of the AV 102 generate based on the position of the door 225 in the environment 240 at the time illustrated in the top-down view 235. The AV 102 can generate the shadow pedestrian and position the shadow pedestrian near the door 225 at a position where a pedestrian would generally exit a doorway of the vehicle corresponding to the door 225.

The AV 102 detects the vehicle 205 in sensor data (e.g., images, depth data) captured by the sensors (e.g., cameras, image sensors, LIDAR, RADAR) of the AV 102. The AV 102 determines a boundary for the vehicle 205 based on its detection of the vehicle in the sensor data. The boundary includes all of the vehicle 205 within the boundary. In some examples, the shape of the boundary is based on the pose of the vehicle 205. The pose of the vehicle 205 includes the location (e.g., latitude, longitude, altitude/elevation) and/or orientation (e.g., pitch, roll, yaw) of the vehicle 205. The AV 102 uses the boundary to determine a route for the AV 102 to move along, so that the route avoids any intersection with the boundary. The bounding box 210 is an example of the boundary for the vehicle 205 at the time illustrated in the top-down view 230. The bounding box 215 is an example of the boundary for the vehicle 205 at the time illustrated in the top-down view 235. The left edge of the bounding box 210 (e.g., the edge closest to the door 225) is also illustrated in the top-down view 235, using a dashed line, to help illustrate that the bounding box 215 is larger than the bounding box 210. The bounding box 215 is larger than the bounding box 210 because the bounding box 215 includes the door 225 in its open state and/or the pedestrian 220. The AV 102 detects the door 225 in sensor data (e.g., images, depth data) captured by the sensors (e.g., cameras, image sensors, LIDAR, RADAR) of the AV 102, and determines the bounding box 215 to include the door 225. In some examples, the AV 102 detects the pedestrian 220 in sensor data (e.g., images, depth data) captured by the sensors (e.g., cameras, image sensors, LIDAR, RADAR) of the AV 102, and determines the bounding box 215 to include the pedestrian 220.

In some examples, the AV 102 detects, in the sensor data, the door 225 but not the pedestrian 220, and the AV 102 generates a simulated “shadow” pedestrian to be the pedestrian 220, and determines the bounding box 215 to include the pedestrian 220. The AV 102 can generate the shadow pedestrian at a position where a pedestrian would generally exit a doorway of the vehicle corresponding to the door 225. In some examples, the addition of the shadow pedestrian can increase the size of the boundary (e.g., the bounding box 215) to include the shadow pedestrian further beyond the increase in size to include the door 225 in its open state. The shadow pedestrian can be added to prepare the AV 102 to route timely, and safe response around a real-world pedestrian who might be entering onto the AV 102's path, for instance upon coming out of a doorway associated with the door, or appearing from an area that the AV 102 does not have good visibility of to enter into the doorway associated with the door. In some examples, the addition of the shadow pedestrian can increase a weight or importance of the boundary (e.g., the bounding box 215) in the AV 102's system(s), because the AV 102's system(s) may be designed so higher importance and/or weight are given to avoiding a collision between the AV 102 and a pedestrian (e.g., pedestrian 220) than to avoiding a collision between the AV 102 and another vehicle (e.g., vehicle 205). Thus, generation of the shadow pedestrian can increase the safety of the AV 102, making the AV 102 more cautious around vehicles whose doors that are at least partially open (e.g., door 225) and/or protruding, as in the top-down view 235.

FIG. 2B is a conceptual diagram illustrating perspective views 260-265 of a bounding box for a vehicle 205 that changes due to detection of a door 225 of the vehicle 205 opening. Two perspective views 260-265 of the environment 240 are illustrated, including a perspective view 260 and a perspective view 265. As in FIG. 2A, the environment 240 includes the AV 102 and the vehicle 205, with the vehicle 205 is in front of and to the right of the AV 102. The perspective view 260 illustrates the environment 240 at the moment in time that is also illustrated in the top-down view 230 of FIG. 2A. The perspective view 265 illustrates the environment 240 at the moment in time that is also illustrated in the top-down view 235 of FIG. 2A. In the perspective view 260, the door 225 of the vehicle 205 is in the closed state. In the perspective view 265, the door 225 of the vehicle 205 is at least partially open and/or protruding from the vehicle 205, and is thus in the open state. In some examples, as indicated by the white arrow in FIG. 2B, the perspective view 265 occurs after the perspective view 260 in time, meaning that the door 225 goes from the closed state to the open state. In some examples, the perspective view 260 instead occurs after the perspective view 265 in time (the reverse of the direction indicated by the white arrow in FIG. 2B), meaning that the door 225 goes from the open state to the closed state.

The pedestrian 220 illustrated coming out of the vehicle 205 in the perspective view 265 through a doorway corresponding to the door 225 is the same pedestrian 220 that is illustrated in the top-down view 235 of FIG. 2A. As in FIG. 2A, in some examples, the pedestrian 220 of the perspective view 265 is a physical pedestrian, for instance a physical pedestrian detected in the sensor data captured by the sensor(s) of the AV 102. As in FIG. 2A, in some examples, the pedestrian 220 of the perspective view 265 is a simulated “shadow” pedestrian, for instance generated by the system(s) of the AV 102 based on the position of the doorway corresponding to the door 225 in order to expand, and/or provide a higher weight and/or importance to, a boundary generated for the vehicle 205 (e.g., the bounding box 215).

The AV 102 determines a boundary for the vehicle 205 based on its detection of the vehicle in the sensor data. The boundary includes all of the vehicle 205 within the boundary. In some examples, the shape of the boundary is based on the pose of the vehicle 205. The pose of the vehicle 205 includes the location (e.g., latitude, longitude, altitude/elevation) and/or orientation (e.g., pitch, roll, yaw) of the vehicle 205. The bounding box 210 is an example of the boundary for the vehicle 205 at the time illustrated in the perspective view 260. The bounding box 215 is an example of the boundary for the vehicle 205 at the time illustrated in the perspective view 265. While the bounding box 210 and the bounding box 215 are illustrated as rectangles in the top-down view 230 and the top-down view 235 of FIG. 2A, the bounding box 210 and the bounding box 215 are illustrated as rectangular prisms in perspective view 260 and the perspective view 265 of FIG. 2B. The side of the bounding box 210 closest to the door 225 is adjacent to the left side of the vehicle 205. The side of the bounding box 215 closest to the door 225 extends beyond the corresponding side of the bounding box 210, which is illustrated using dashed lines in the perspective view 265. The side of the bounding box 215 closest to the door 225 extends beyond the corresponding side of the bounding box 210 to include the door 225 in its open state and/or to include the pedestrian 220.

In some examples, the boundary for the vehicle may be, or may include, a 2D polygon, such as a rectangle, a triangle, a square, a trapezoid, a parallelogram, a quadrilateral, a pentagon, a hexagon, another polygon, a portion thereof, or a combination thereof. In some examples, the boundary for the vehicle may be, or may include, a circle, a semicircle, an ellipse, another rounded 2D shape, a portion thereof, or a combination thereof. In some examples, the boundary for the vehicle may be, or may include, a 3D polyhedron, such as a rectangular prism, a cube, a pyramid, a triangular prism, a prism of a another polygon, a tetrahedron, another polyhedron, a portion thereof, or a combination thereof. In some examples, the boundary for the vehicle may be, or may include, a sphere, an ellipsoid, a cone, a cylinder, another rounded 3D shape, a portion thereof, or a combination thereof.

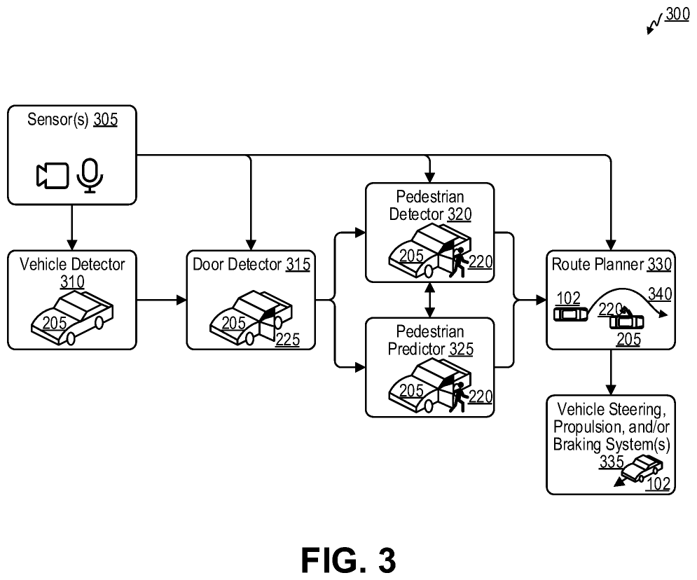

FIG. 3 is a block diagram illustrating an environment analysis and routing system 300. The environment analysis and routing system 300 includes one or more sensors 305 of the AV 102. The sensor(s) 305 can include, for instance, the sensor system 1 104, the sensor system 2 106, the sensor system 3 108, the sensor(s) 405, the sensor(s) 415, the image sensor 515, the range sensor 525, the image sensor 660, the image sensor(s) 705, the range sensor(s) 710, the input device(s) 1245, any other sensors or sensors systems described herein, or a combination thereof. In an illustrative example, the sensor(s) 305 include range sensor(s) (e.g., LIDAR, RADAR, SONAR, SODAR, ToF, structured light) and/or image sensor(s) of camera(s). The sensor(s) 305 capture sensor data. Range sensors may be referred to as depth sensors. The sensor data can include, for example, image data (e.g., one or more images and/or videos) captured by image sensor(s) of camera(s) of the AV 102. The sensor data can include, for example, range data (e.g., one or more point clouds, range images, range videos, 3D models, and/or distance measurements) captured by range sensor(s) of the AV 102. The sensor data can include one or more representations of at least portion(s) of an environment around the AV 102. In some examples, the one or more representations can include depiction(s) of portion(s) of the environment in image(s) and/or video(s) captured by image sensor(s) of camera(s) of the AV 102. In some examples, the one or more representations can include depth representation(s) of portion(s) of the environment in depth data captured by depth sensor(s) of camera(s) of the AV 102.

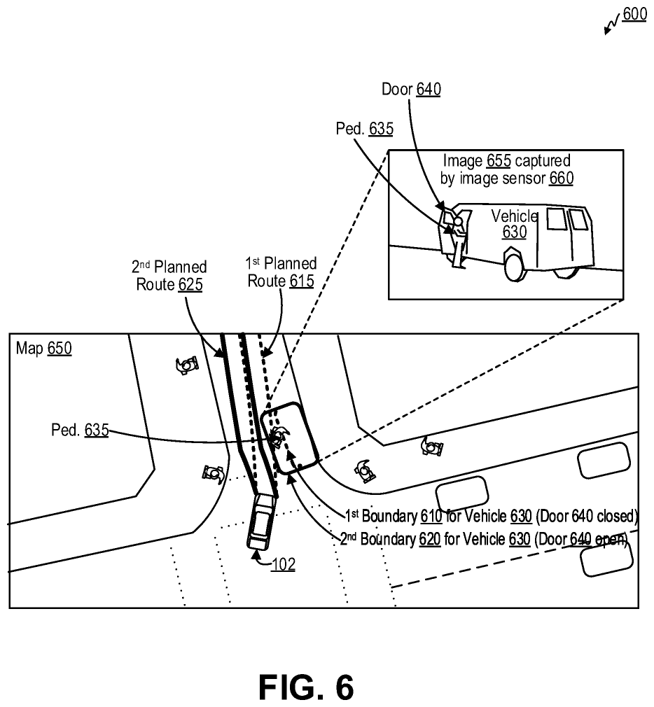

The environment analysis and routing system 300 includes a vehicle detector 310. The vehicle detector 310 receives, from the sensor(s) 305, sensor data captured by the sensor(s) 305. The vehicle detector 310 receives the sensor data and detects a vehicle 205 in the environment. For instance, the vehicle detector 310 can detect representation(s) of the vehicle 205 within representation(s) of at least portion(s) of the environment in the sensor data. In some examples, the vehicle detector 310 fuses sensor data from different sensor modalities (e.g., image data and range data) together as part of vehicle detection. In some examples, the vehicle detector 310 generates a boundary for the vehicle 205. The boundary includes all of the vehicle 205 within the boundary. In some cases, the boundary includes a door 225 and/or a pedestrian 220. In some examples, the environment analysis and routing system 300 can generate a map of the environment (e.g., the map 650 of FIG. 6), and the pedestrian detector 320 can add the pedestrian 220 to the map.

In some examples, the vehicle detector 310 determines a predicted path of the vehicle 205. For instance, the vehicle detector 310 can determine a pose of the vehicle 205 in the environment, and predict that the vehicle 205 will move in the direction the vehicle 205 is facing. In some examples, the shape of the boundary is based on the pose of the vehicle 205 (e.g., location and/or orientation of the vehicle 205) and/or the predicted path of the vehicle 205. Examples of the boundary include the bounding box 210 of FIGS. 2A-2B, the bounding box 215 of FIGS. 2A-2B, the first boundary 610 of FIG. 6, the second boundary 620 of FIG. 6, another bounding box for a vehicle described herein, another boundary for a vehicle described herein, or a combination thereof. The vehicle detector 310 can output, for instance, a pose of the vehicle 205 in the sensor data (e.g., in a particular image of the environment or depth data representation of the environment), a pose of the vehicle 205 within the environment, a boundary of the vehicle 205 in the sensor data, a boundary of the vehicle 205 within the environment, one or more confidence values associated with any of the previous determinations, or a combination thereof. In some examples, the boundary of the vehicle 205 as discussed herein may include at least a portion of the predicted path of the vehicle 205.

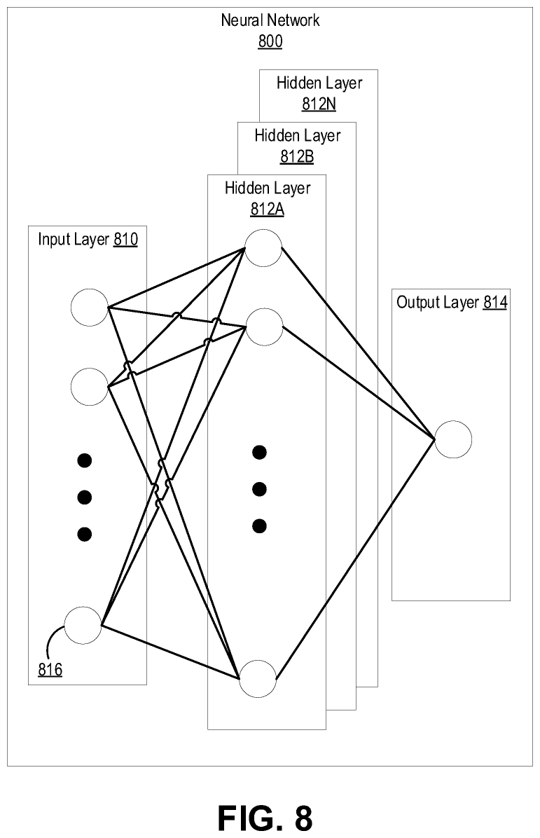

In some examples, the vehicle detector 310 includes and/or uses one or more trained machine learning (ML) models of one or more ML systems to detect the vehicle 205 using the sensor data from the sensor(s) 305. In some examples, the vehicle detector 310 provides the sensor data from the sensor(s) 305 as input(s) to the trained ML model(s). In response to receipt of the sensor data as input(s), the trained ML model(s) output information about the vehicle 205, for instance including the pose of the vehicle 205 in the sensor data, the pose of the vehicle 205 within the environment, the boundary of the vehicle 205 in the sensor data, the boundary of the vehicle 205 within the environment, confidence value(s) for any of the prior determinations, or a combination thereof. The ML system(s) may train the trained ML model(s) using training data, for instance using supervised learning, unsupervised learning, deep learning, or combinations thereof. The training data may include sensor data that includes representations of environments with representations of vehicle(s) therein. The representations of vehicle(s) may be previously identified in the training data. The one or more ML systems, and/or the trained ML model(s), may include, for instance, one or more neural networks (NNs) (e.g., the NN 800 of FIG. 8), one or more convolutional neural networks (CNNs), one or more trained time delay neural networks (TDNNs), one or more deep networks, one or more autoencoders, one or more deep belief nets (DBNs), one or more recurrent neural networks (RNNs), one or more generative adversarial networks (GANs), one or more other types of neural networks, one or more trained support vector machines (SVMs), one or more trained random forests (RFs), or combinations thereof.

The environment analysis and routing system 300 includes a door detector 315. The door detector 315 receives, from the sensor(s) 305, sensor data captured by the sensor(s) 305. The door detector 315 receives the sensor data and detects a door 225 of the vehicle 205 in the environment. For instance, the door detector 315 can detect representation(s) of the door 225 within representation(s) of at least portion(s) of the environment in the sensor data. In some examples, the door detector 315 fuses sensor data from different sensor modalities (e.g., image data and range data) together as part of door detection. In some examples, the door detector 315 receives a pose of the vehicle 205 and/or a boundary for the vehicle 205 from the vehicle detector 310, and detects the door 225 based on the pose of the vehicle 205 and/or the boundary for the vehicle 205. In some examples, the environment analysis and routing system 300 can generate a map of the environment (e.g., the map 650 of FIG. 6), and the door detector 315 can add the door 225 to the map. For example, the door detector 315 may limit its search for the door 225 to areas in the vicinity (e.g., within a predetermined threshold distance) of the vehicle 205 and/or the boundary of the vehicle 205. In some examples, the door detector 315 is part of the vehicle detector 310. For instance, in some examples, the vehicle detector 310 detects both the vehicle 205 and its door 225.

In some examples, the door detector 315 determines a predicted path of the door 225. For instance, the door detector 315 can determine a pose of the door 225 in the environment while the door 225 is partially open and/or protruding from the vehicle 205, and predict that the door 225 will continue to move until the door 225 is fully open. Similarly, the door detector 315 can determine a pose of the door 225 in the environment while the door 225 is partially open and/or protruding from the vehicle 205, and predict that the door 225 will continue to move until the door 225 is closed. In some examples, upon detection of the door 225 of the vehicle 205, the door detector 315 modifies the boundary of the vehicle 205 that is generated by the vehicle detector 310, so that the modified boundary includes the door 225 and/or the predicted path of the door 225. In some examples, the door detector 315 generates a boundary for the door 225 that includes the door 225 and/or the predicted path of the door 225, and then combines the boundary for the door 225 with the boundary of the vehicle 205 that is generated by the vehicle detector 310 to create a combined boundary that includes the vehicle 205 and its door 225 (and/or the door 225's path). In some examples, the door detector 315 generates a boundary for the vehicle 205 and its door 225 (and/or the door 225's path) that includes the vehicle 205 and its door 225 (and/or the door 225's path). Examples of the boundary that includes both a vehicle 205 and its door 225 include the bounding box 215 of FIGS. 2A-2B, the second boundary 620 of FIG. 6, another bounding box for a vehicle and its door described herein, another boundary for a vehicle and its door described herein, or a combination thereof. The door detector 315 can output, for instance, a pose of the door 225 in the sensor data (e.g., in a particular image of the environment or depth data representation of the environment), a pose of the door 225 within the environment, a boundary of the door 225 in the sensor data, a boundary of the door 225 within the environment, one or more confidence values associated with any of the previous determinations, or a combination thereof.

In some examples, the door detector 315 includes and/or uses trained ML model(s) of ML system(s) to detect the door 225 using the sensor data from the sensor(s) 305. In some examples, the door detector 315 provides the sensor data from the sensor(s) 305, and/or the vehicle information output by the vehicle detector 310, as input(s) to the trained ML model(s). In response to receipt of the sensor data and/or the vehicle information as input(s), the trained ML model(s) output information about the door 225, for instance including the pose of the door 225 in the sensor data, the pose of the door 225 within the environment, the boundary of the door 225 in the sensor data, the boundary of the door 225 within the environment, confidence value(s) for any of the prior determinations, or a combination thereof. The ML system(s) may train the trained ML model(s) using training data, for instance using supervised learning, unsupervised learning, deep learning, or combinations thereof. The training data may include sensor data that includes representations of environments with representations of door(s) therein. The representations of door(s) may be previously identified in the training data. The trained ML model(s) included in and/or used by the door detector 315 may be the same trained ML model(s) that are included in and/or used by the vehicle detector 310. The trained ML model(s) included in and/or used by the door detector 315 may be different than the trained ML model(s) included in and/or used by the vehicle detector 310. The ML system(s) and/or trained ML model(s) included in and/or used by the door detector 315 may include a neural network (e.g., NN 800) and/or any of the other types of ML system(s) and/or trained ML model(s) listed with respect to vehicle detector 310.

In some cases, if the door detector 315 detects a door 225 that is opening, the door detector 315 can use translation and/or rotation to predict the pose of the door 225 when the door 225 is fully open (or use previously-captured data from a time when the door 225 was previously fully open). The door detector 315 can treat this predicted pose of the door 225 while fully open as the current pose of the door 225, for instance while generating the boundarie(s) for the vehicle 205 and/or the door 225. This may increase safety, as the door 225 may reach the fully open position by the time the AV 102 approaches the vehicle 205 even if the door 225 is not fully open yet when the AV 102 detects the door 225.

In some cases, if the door detector 315 detects a door 225 that is closing, the door detector 315 can use translation and/or rotation to predict the pose of the door 225 when the door 225 is fully closed (or use previously-captured data from a time when the door 225 was previously fully closed). The door detector 315 can treat this predicted pose of the door 225 while fully closed as the current pose of the door 225, for instance while generating the boundarie(s) for the vehicle 205 and/or the door 225. This may give the route planner 330 of the AV 102 more options in terms of route 340, as the door 225 may reach the fully closed position by the time the AV 102 approaches the vehicle 205 even if the door 225 is not fully closed yet when the AV 102 detects the door 225.

The environment analysis and routing system 300 includes a pedestrian detector 320. The pedestrian detector 320 receives, from the sensor(s) 305, sensor data captured by the sensor(s) 305. The pedestrian detector 320 receives the sensor data and detects a pedestrian 220 associated with the vehicle 205 in the environment. The pedestrian 220 may be exiting a doorway corresponding to the door 225 of the vehicle 205, entering the doorway corresponding to the door 225 of the vehicle 205, lingering at least partway in the a doorway corresponding to the door 225 of the vehicle 205, lingering in the vicinity (e.g., within a threshold distance) of the doorway corresponding to the door 225 of the vehicle 205, or a combination thereof. For instance, the pedestrian detector 320 can detect representation(s) of the pedestrian 220 within representation(s) of at least portion(s) of the environment in the sensor data. In some examples, the pedestrian detector 320 fuses sensor data from different sensor modalities (e.g., image data and range data) together as part of pedestrian detection. In some examples, the pedestrian detector 320 receives a pose and/or a boundary for the vehicle 205 from the vehicle detector 310, and/or a pose and/or a boundary for the door 225. In some examples, the environment analysis and routing system 300 can generate a map of the environment (e.g., the map 650 of FIG. 6), and the pedestrian detector 320 can add the pedestrian 220 to the map. The pedestrian detector 320 can detect the pedestrian 220 based on the pose for the vehicle 205, the boundary for the vehicle 205, the pose for the door 225, the boundary for the door 225, or a combination thereof. For example, the pedestrian detector 320 may limit its search for the pedestrian 220 to areas in the vicinity (e.g., within a predetermined threshold distance) of the vehicle 205 and/or the door 225, and/or the boundary of the vehicle 205 and/or the door 225. In some examples, the pedestrian detector 320 is part of the vehicle detector 310 and/or the door detector 315. For instance, the vehicle detector 310 can detect both the vehicle 205 and the pedestrian 220. Similarly, the door detector 315 can detect both the door 225 and the pedestrian 220.

In some examples, the pedestrian detector 320 determines a predicted path of the pedestrian 220. For instance, the pedestrian detector 320 can determine a pose of the pedestrian 220 in the environment, and predict that the pedestrian 220 will walk, run, or otherwise move in the direction the pedestrian 220 is facing. The pedestrian detector 320 can predict that the pedestrian 220 will walk, run, or otherwise move in a direction toward the vehicle 205 (e.g., toward the doorway corresponding to the door 225), away from the vehicle 205 (e.g., away from the doorway corresponding to the door 225), or another direction. In some examples, upon detection of the pedestrian 220, the pedestrian detector 320 modifies the boundary of the vehicle 205 that is generated by the vehicle detector 310, so that the modified boundary includes the pedestrian 220 and/or the predicted path of the pedestrian 220. In some examples, the pedestrian detector 320 generates a boundary for the pedestrian 220 that includes the pedestrian 220 (and/or the pedestrian 220's path), and then combines the boundary for the pedestrian 220 with the boundary of the vehicle 205 that is generated by the vehicle detector 310 and/or the boundary of the door 225 that is generated by the door detector 315 to create a combined boundary that includes the vehicle 205, the door 225, and/or the pedestrian 220 (and/or the pedestrian 220's path). In some examples, the pedestrian detector 320 generates a boundary for the vehicle 205 and its pedestrian 220 (and/or the pedestrian 220's path) that includes the vehicle 205 and its pedestrian 220 (and/or the pedestrian 220's path). Examples of the boundary that includes both a vehicle 205 and the pedestrian 220 include the bounding box 215 of FIGS. 2A-2B, the second boundary 620 of FIG. 6, another bounding box for a vehicle and a pedestrian described herein, another boundary for a vehicle and a pedestrian described herein, or a combination thereof. The pedestrian detector 320 can output, for instance, a pose of the pedestrian 220 in the sensor data (e.g., in a particular image of the environment or depth data representation of the environment), a pose of the pedestrian 220 within the environment, a boundary of the pedestrian 220 in the sensor data, a boundary of the pedestrian 220 within the environment, one or more confidence values associated with any of the previous determinations, or a combination thereof.

In some examples, the pedestrian detector 320 includes and/or uses trained ML model(s) of ML system(s) to detect the pedestrian 220 using the sensor data from the sensor(s) 305. In some examples, the pedestrian detector 320 provides the sensor data from the sensor(s) 305, the vehicle information output by the vehicle detector 310, and/or the door information output by the door detector 315, as input(s) to the trained ML model(s). In response to receipt of the sensor data and/or the vehicle information and/or the door information as input(s), the trained ML model(s) output information about the pedestrian 220, for instance including the pose of the pedestrian 220 in the sensor data, the pose of the pedestrian 220 within the environment, the boundary of the pedestrian 220 in the sensor data, the boundary of the pedestrian 220 within the environment, confidence value(s) for any of the prior determinations, or a combination thereof. The ML system(s) may train the trained ML model(s) using training data, for instance using supervised learning, unsupervised learning, deep learning, or combinations thereof. The training data may include sensor data that includes representations of environments with representations of pedestrian(s) therein. The representations of pedestrian(s) may be previously identified in the training data. The trained ML model(s) included in and/or used by the pedestrian detector 320 may be the same trained ML model(s) that are included in and/or used by the vehicle detector 310 and/or the door detector 315. The trained ML model(s) included in and/or used by the pedestrian detector 320 may be different than the trained ML model(s) included in and/or used by the vehicle detector 310 and/or the door detector 315. The ML system(s) and/or trained ML model(s) included in and/or used by the pedestrian detector 320 may include a neural network (e.g., NN 800) and/or any of the other types of ML system(s) and/or trained ML model(s) listed with respect to vehicle detector 310.

The environment analysis and routing system 300 includes a pedestrian predictor 325. The pedestrian predictor 325 receives, from the sensor(s) 305, sensor data captured by the sensor(s) 305. The pedestrian predictor 325 receives the sensor data and generates a predicted pose (e.g., location and/or orientation) for a pedestrian 220 (e.g., a predicted “shadow” pedestrian) associated with the vehicle 205 positioned in the environment. In some cases, the pedestrian predictor 325 can generate the pedestrian 220 in situations where a door 225 that is at least partially open (and/or protruding from the vehicle 205) is detected by the door detector 315, but no pedestrian is detected by the pedestrian detector 320 in the vicinity of the doorway corresponding to the door 225. The pedestrian predictor 325 can generate the shadow pedestrian to compensate for shortcomings of certain sensor(s) 305 in certain conditions. For instance, if the environment is dark (e.g., nighttime and/or poorly illuminated), the pedestrian detector 320 may fail to detect a pedestrian 220 in camera images even when a pedestrian 220 is in the vicinity of the doorway corresponding to the door 225. Similarly, if the environment is very bright (e.g., daytime and/or brightly illuminated), the pedestrian detector 320 may fail to detect a pedestrian 220 in LIDAR data due to reflectance confusion, even when a pedestrian 220 is in the vicinity of the doorway corresponding to the door 225. The pedestrian predictor 325 can generate the shadow pedestrian as a precaution even when no actual pedestrian 220 exists, to mark a position that a pedestrian may suddenly emerge from the vehicle 205, so that the AV 102 is ready for that eventuality. The pedestrian predictor 325 can generate the shadow pedestrian so that the pose of the shadow pedestrian simulates the pose of a pedestrian 220 that is exiting a doorway corresponding to the door 225 of the vehicle 205, that is entering the doorway corresponding to the door 225 of the vehicle 205, that is lingering at least partway in the a doorway corresponding to the door 225 of the vehicle 205, that is lingering in the vicinity (e.g., within a threshold distance) of the doorway corresponding to the door 225 of the vehicle 205, or a combination thereof. In some examples, the environment analysis and routing system 300 can generate a map of the environment (e.g., the map 650 of FIG. 6), and the pedestrian predictor 325 can add the shadow pedestrian to the map. In some examples, the pedestrian predictor 325 can modify sensor data from the sensor(s) 305 to add the shadow pedestrian to the sensor data. In some examples, the pedestrian predictor 325 receives a pose and/or a boundary for the vehicle 205 from the vehicle detector 310, and/or a pose and/or a boundary for the door 225. The pedestrian predictor 325 can generate the shadow pedestrian so that the pose of the shadow pedestrian is based on the pose for the vehicle 205, the boundary for the vehicle 205, the pose for the door 225, the boundary for the door 225, or a combination thereof. For example, the pedestrian predictor 325 may limit its generation of the shadow pedestrian to areas in the vicinity (e.g., within a predetermined threshold distance) of the vehicle 205 and/or the door 225, and/or the boundary of the vehicle 205 and/or the door 225. In some examples, the pedestrian predictor 325 is part of the vehicle detector 310, the door detector 315, and/or the pedestrian detector 320.

In some examples, the pedestrian predictor 325 generates and/or determines a predicted path of the shadow pedestrian. For instance, the pedestrian predictor 325 can determine a pose of the shadow pedestrian in the environment, and determine that the shadow pedestrian will walk, run, or otherwise move in the direction the shadow pedestrian is facing. The pedestrian predictor 325 can predict that the shadow pedestrian will walk, run, or otherwise move in a direction toward the vehicle 205 (e.g., toward the doorway corresponding to the door 225), away from the vehicle 205 (e.g., away from the doorway corresponding to the door 225), or another direction. In some examples, upon generation of the shadow pedestrian, the pedestrian predictor 325 modifies the boundary of the vehicle 205 that is generated by the vehicle detector 310, so that the modified boundary includes the shadow pedestrian and/or the predicted path of the shadow pedestrian. In some examples, the pedestrian predictor 325 generates a boundary for the shadow pedestrian that includes the shadow pedestrian (and/or the shadow pedestrian's path), and then combines the boundary for the shadow pedestrian with the boundary of the vehicle 205 that is generated by the vehicle detector 310 and/or the boundary of the door 225 that is generated by the door detector 315 to create a combined boundary that includes the vehicle 205, the door 225, and/or the shadow pedestrian (and/or the shadow pedestrian's path). In some examples, the pedestrian predictor 325 generates a boundary for the vehicle 205 and its shadow pedestrian (and/or the shadow pedestrian's path) that includes the vehicle 205 and its shadow pedestrian (and/or the shadow pedestrian's path). Examples of the boundary that includes both a vehicle 205 and the shadow pedestrian include the bounding box 215 of FIGS. 2A-2B, the second boundary 620 of FIG. 6, another bounding box for a vehicle and a pedestrian described herein, another boundary for a vehicle and a pedestrian described herein, or a combination thereof. The pedestrian predictor 325 can output, for instance, a pose of the shadow pedestrian in the sensor data (e.g., in a particular image of the environment or depth data representation of the environment), a pose of the shadow pedestrian within the environment, a boundary of the shadow pedestrian in the sensor data, a boundary of the shadow pedestrian within the environment, one or more confidence values associated with any of the previous determinations, or a combination thereof.

In some examples, the pedestrian predictor 325 includes and/or uses trained ML model(s) of ML system(s) to generate the shadow pedestrian based on the sensor data from the sensor(s) 305. In some examples, the pedestrian predictor 325 provides the sensor data from the sensor(s) 305, the vehicle information output by the vehicle detector 310, the door information output by the door detector 315, and/or the pedestrian information output by the pedestrian detector 320, as input(s) to the trained ML model(s). In response to receipt of the sensor data and/or the vehicle information and/or the door information and/or the pedestrian information as input(s), the trained ML model(s) output information about the shadow pedestrian, for instance including the pose of the shadow pedestrian in the sensor data, the pose of the shadow pedestrian within the environment, the boundary of the shadow pedestrian in the sensor data, the boundary of the shadow pedestrian within the environment, confidence value(s) for any of the prior determinations, or a combination thereof. The ML system(s) may train the trained ML model(s) using training data, for instance using supervised learning, unsupervised learning, deep learning, or combinations thereof. The training data may include sensor data that includes representations of environments with representations of pedestrian(s) therein. The representations of pedestrian(s) may be previously identified in the training data. The trained ML model(s) included in and/or used by the pedestrian predictor 325 may be the same trained ML model(s) that are included in and/or used by the vehicle detector 310, the door detector 315, and/or the pedestrian detector 320. The trained ML model(s) included in and/or used by the pedestrian predictor 325 may be different than the trained ML model(s) included in and/or used by the vehicle detector 310, the door detector 315, and/or the pedestrian detector 320. The ML system(s) and/or trained ML model(s) included in and/or used by the pedestrian predictor 325 may include a neural network (e.g., NN 800) and/or any of the other types of ML system(s) and/or trained ML model(s) listed with respect to vehicle detector 310.

The environment analysis and routing system 300 includes a route planner 330. The route planner 330 receives sensor data from the sensor(s) 305, vehicle information about a vehicle 205 detected by the vehicle detector 310, door information about a door 225 detected by the door detector 315, pedestrian information about a pedestrian 220 detected by the pedestrian detector 320, pedestrian information about a shadow pedestrian generated by the pedestrian predictor 325, or a combination thereof. The route planner 330 generates a route 340 for the AV 102 based on the sensor data, the vehicle information about the vehicle 205, the door information about the door 225, the pedestrian information about the pedestrian 220, the pedestrian information about the shadow pedestrian, or a combination thereof. The route planner 330 generates the route 340 for the AV 102 to avoid the vehicle 205, the door 225, the pedestrian 220, the shadow pedestrian, predicted path(s) associated with any of these elements, boundarie(s) associated with any of these elements, or a combination thereof. In some examples, the route planner 330 generates the route 340 for the AV 102 by modifying a previously-planned route for the AV 102 so that the modified route avoids the vehicle 205, the door 225, the pedestrian 220, the shadow pedestrian, predicted path(s) associated with any of these elements, boundarie(s) associated with any of these elements, or a combination thereof. In some examples, the route 340 includes movements of the AV 102 along a path. In some examples, the route 340 includes accelerations and/or decelerations of the AV 102. In some examples, the route 340 includes turns and/or rotations of the AV 102. In some examples, the route 340 includes stops by the AV 102, for instance to stop before the AV 102 collides with a boundary.

In some examples, the route planner 330 includes and/or uses trained ML model(s) of ML system(s) to generate the route 340 based on the sensor data from the sensor(s) 305, the vehicle information about a vehicle 205 detected by the vehicle detector 310, the door information about a door 225 detected by the door detector 315, the pedestrian information about a pedestrian 220 detected by the pedestrian detector 320, the pedestrian information about a shadow pedestrian generated by the pedestrian predictor 325, or a combination thereof. In some examples, the route planner 330 provides, as input(s) to the trained ML model(s), the sensor data from the sensor(s) 305, the vehicle information output by the vehicle detector 310, the door information output by the door detector 315, and/or the pedestrian information output by the pedestrian detector 320,. In response to receipt of the sensor data, the vehicle information, the door information, and/or the pedestrian information as input(s), the trained ML model(s) output information about the route 340. For instance, the information about the route 340 output by the trained ML model(s) can include the route 340, a delta between the route 340 and a previously-planned route for the AV 102, confidence value(s) for any of the prior determinations, or a combination thereof. The ML system(s) may train the trained ML model(s) using training data, for instance using supervised learning, unsupervised learning, deep learning, or combinations thereof. The training data may include routes through environments that avoid certain boundaries (e.g., associated with vehicles, doors, pedestrians, and/or other objects). The trained ML model(s) included in and/or used by the route planner 330 may be the same trained ML model(s) that are included in and/or used by the vehicle detector 310, the door detector 315, the pedestrian detector 320, and/or the pedestrian predictor 325. The trained ML model(s) included in and/or used by the route planner 330 may be different than the trained ML model(s) included in and/or used by the vehicle detector 310, the door detector 315, the pedestrian detector 320, and/or the pedestrian predictor 325. The ML system(s) and/or trained ML model(s) included in and/or used by the route planner 330 may include a neural network (e.g., NN 800) and/or any of the other types of ML system(s) and/or trained ML model(s) listed with respect to vehicle detector 310.

In some examples, the route planner 330 uses a graph search algorithm to understand the lateral space around the AV 102 in the environment, and/or to determine the route 340. The graph search algorithm can seek to avoid boundaries and/or obstacles based on weight. For instance, in an illustrative example, pedestrians 220 (real or shadow) may have higher weight than bicyclists, which may have higher weight than cars. The graph search algorithm can thus more aggressively avoid pedestrians 220 than bicyclists or cars, and can more aggressively avoid bicyclists than cars. Thus, generation of the shadow pedestrian by the pedestrian predictor 325 can aid in encouraging the AV 102 to avoid a door 225.

The environment analysis and routing system 300 includes vehicle steering, propulsion, and/or braking system(s) 335 of the AV 102. The vehicle steering, propulsion, and/or braking system(s) 335 may include, for example, the vehicle propulsion system 130, the braking system 132, the steering system 134, or a combination thereof. The environment analysis and routing system 300 may cause the AV 102 to follow the route 340 using the vehicle steering, propulsion, and/or braking system(s) 335 of the AV 102. The vehicle steering, propulsion, and/or braking system(s) 335 of the AV 102 may move the AV 102 according to the route 340, accelerate the AV 102 according to the route 340, decelerate the AV 102 according to the route 340, turn the AV 102 according to the route 340, and/or stop the AV 102 according to the route 340.

In some examples, the environment analysis and routing system 300 may use temporal modeling. For instance, the environment analysis and routing system 300 can remember previously-detected poses of vehicle(s) 205, door(s) 225, and/or pedestrians 220 (real or shadow) in the environment when performing detections. Temporal modeling reduces “flickering” artifacts in object detection, in which an object is detected at one moment, not detected in the next, and detected again in the next after that. Temporal modeling increases the confidence of the environment analysis and routing system 300 in detecting an object (e.g., vehicle 205, door 225, and/or pedestrian 220) in a similar pose in the environment compared to a previous detection of the object, which can bring the confidence value up to exceed a confidence threshold that might otherwise not be met (e.g., which would have resulted in a false negative). Temporal modeling can decrease the confidence of the environment analysis and routing system 300 in detecting an object (e.g., vehicle 205, door 225, and/or pedestrian 220) in a very different pose in the environment compared to a previous detection of the object, which can bring the confidence value down to below confidence threshold that might otherwise be met (e.g., which would have resulted in a false positive).

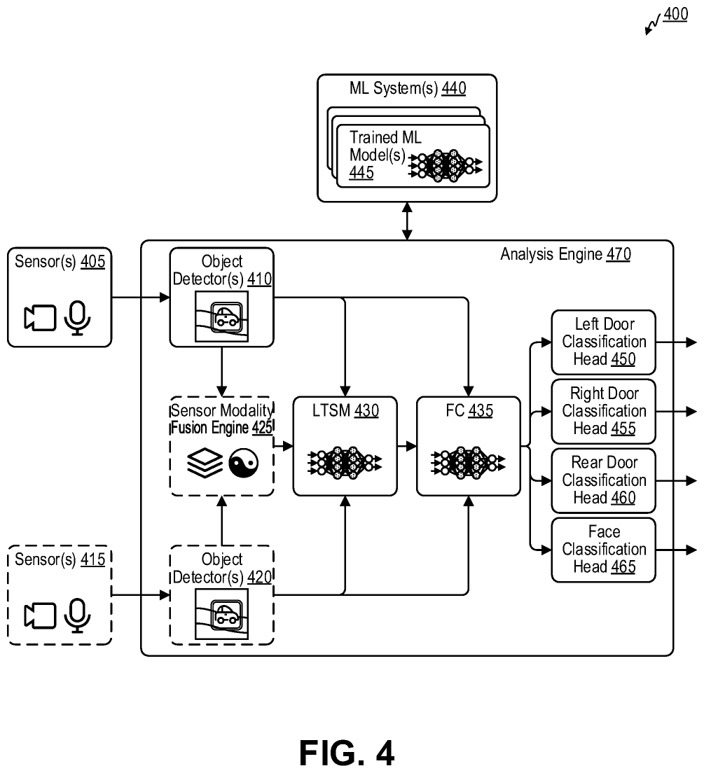

FIG. 4 is a block diagram illustrating an environment analysis system 400. The environment analysis system 400 may be an example of at least a portion of the environment analysis and routing system 300. For instance, the environment analysis system 400 may be an example of the sensor(s) 305, the vehicle detector 310, the door detector 315, the pedestrian detector 320, ML system(s) of the environment analysis and routing system 300, trained ML model(s) of the environment analysis and routing system 300, or a combination thereof.

The environment analysis system 400 includes a first set of sensor(s) 405. In some examples, the environment analysis system 400 also includes a second set of sensor(s) 415. Examples of the first set of sensor(s) 405, and/or of the second set of sensor(s) 415, include any of the sensors described with respect to the sensor system 1 104, the sensor system 2 106, the sensor system 3 108, the sensor(s) 305, the image sensor 515, the range sensor 525, the image sensor 660, the image sensor(s) 705, the range sensor(s) 710, the input device(s) 1245, any other sensors described herein, or a combination thereof. The first set of sensor(s) 405 and the second set of sensor(s) 415 are at least partially distinct. In some examples, there is at least one sensor that is in the first set of sensor(s) 405 but not in the second set of sensor(s) 415. In some examples, there is at least one sensor that is in the second set of sensor(s) 415 but not in the first set of sensor(s) 405. In some examples, there is at least one sensor that is in both the first set of sensor(s) 405 and the second set of sensor(s) 415.

The environment analysis system 400 includes an analysis engine 470 that analyzes the sensor data from the first set of sensor(s) 405 and/or the sensor data from the second set of sensor(s) 415. The analysis engine 470 includes one or more object detector(s) 410 that detect one or more object(s) (e.g., vehicle 205, door 225, and/or pedestrian 220) in the sensor data from the first set of sensor(s) 405. In some examples, the analysis engine 470 includes one or more object detector(s) 420 that detect one or more object(s) (e.g., vehicle 205, door 225, and/or pedestrian 220) in the sensor data from the second set of sensor(s) 415.

In some examples, the first set of sensor(s) 405 includes a first type of sensor(s), and the object detector(s) 410 may be configured to detect object(s) in sensor data captured by the first type of sensor(s). In some examples, the second set of sensor(s) 415 includes a second type of sensor(s), and the object detector(s) 420 may be configured to detect object(s) in sensor data captured by the second type of sensor(s). In an illustrative example, the first set of sensor(s) 405 includes image sensor(s) of camera(s), and the object detector(s) 410 are configured to detect object(s) in image(s) captured by the image sensor(s). In an illustrative example, the second set of sensor(s) 415 includes range sensor(s) (e.g., LIDAR), and the object detector(s) 420 are configured to detect object(s) in range data captured by the range sensor(s). Some examples of the object detector(s) 410 and/or the object detector(s) 420 include ResNet object detectors and/or PointNet object detectors. The object detector(s) 410 and/or object detector(s) 420 can include a feature detection algorithm, a feature extraction algorithm, a feature recognition algorithm, a feature tracking algorithm, an object detection algorithm, an object recognition algorithm, an object tracking algorithm, a facial detection algorithm, a facial recognition algorithm, a facial tracking algorithm, a person detection algorithm, a person recognition algorithm, a person tracking algorithm, a vehicle detection algorithm, a vehicle recognition algorithm, a vehicle tracking algorithm, a classifier, or a combination thereof.

In some examples, the analysis engine 470 includes a sensor modality fusion engine 425 that fuses object detection data from the object detector(s) 410, object detection data from the object detector(s) 420, sensor data from the sensor(s) 405, and/or sensor data from the sensor(s) 415. The sensor modality fusion engine 425 can fuse sensor data and/or object detection corresponding to a first sensor modality (e.g., image data from image sensor(s)) with sensor data and/or object detection corresponding to a second sensor modality (e.g., range data from range sensor(s)). The fusion performed by the sensor modality fusion engine 425 may occur at different levels, such as fusion in the feature space, in the embedding space, or a combination thereof. For instance, in feature space fusion, the sensor modality fusion engine 425 takes raw sensor signals from the sensors of the AV 102 (e.g., LIDAR and camera) and fuses the sensor signal data directly. In embedding space fusion, the AV 102 transforms the raw sensor signal data into a different space and/or dimension compared to the raw sensor signal data, and the sensor modality fusion engine 425 fuses the transformed data in the different space and/or dimension. One benefit of fusion in the embedding space is decoupling sensor backbones (e.g., image and range sensor backbones) from the analysis. Another benefit of fusion in the embedding space is that the analysis engine can more easily determine which sensor modality contributes more to a confidence level of detection and/or classification (e.g., of a vehicle 205, door 225, and/or pedestrian 220).

The environment analysis system 400 includes a long short-term memory (LSTM) 430 recurrent neural network (RNN) architecture and a fully connected (FC) 435 neural network architecture. The analysis engine 470 may include, and/or use, one or more ML systems 440 that train one or more ML models 445. The ML system(s) 440, and/or the trained ML model(s) 445, may include, for instance, one or more neural networks (NNs) (e.g., the NN 800 of FIG. 8), one or more convolutional neural networks (CNNs), one or more trained time delay neural networks (TDNNs), one or more deep networks, one or more autoencoders, one or more deep belief nets (DBNs), one or more recurrent neural networks (RNNs), one or more generative adversarial networks (GANs), one or more other types of neural networks, one or more trained support vector machines (SVMs), one or more trained random forests (RFs), or combinations thereof. The ML system(s) 440, and/or the trained ML model(s) 445, may include trained ML model(s) corresponding to the object detector(s) 410, trained ML model(s) corresponding to the object detector(s) 420, trained ML model(s) corresponding to the sensor modality fusion engine 425, trained ML model(s) corresponding to the LSTM 430 architecture, and/or trained ML model(s) corresponding to the FC 435 architecture. The LSTM 430 architecture provides a temporal model that processes sequences of data (e.g., video, depth video, and/or point cloud video) from the sensors of the AV 102, and that is proficient at detecting transitions, for instance including opening of doors, closing of doors, emergence of pedestrians from doorways, entry of pedestrians into doorways, or combinations thereof.

The ML system(s) 440 and/or the analysis engine 470 may train the trained ML model(s) 445 using training data, for instance with a left door classification head 450, a right door classification head 455, a rear door (e.g., trunk, boot) classification head 460, a face (e.g., of a pedestrian 220) classification head 465, or a combination thereof. This way, the ML system(s) 440 and/or the analysis engine 470 may detect vehicle(s), door(s), and/or pedestrian(s), and may further classify door(s) (and/or pedestrian(s)) by the side of the vehicle (e.g., left side of the vehicle, right side of the vehicle, or rear of the vehicle).

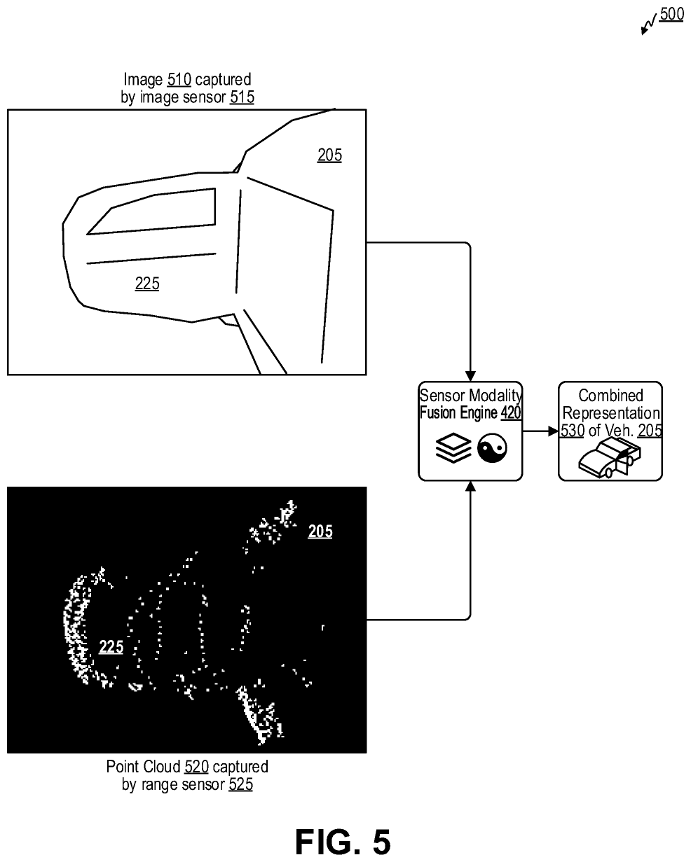

FIG. 5 is a conceptual diagram 500 illustrating fusion of an image 510 and a point cloud 520. The image 510 is an example of an image of a vehicle 205 with a door 225 that is at least partially open and/or protruding from the vehicle 205, as captured by an image sensor 515 of an AV 102. The point cloud 520 is an example of a point cloud of a vehicle 205 with a door 225 that is at least partially open and/or protruding from the vehicle 205, as captured by a range sensor 525 (e.g., LIDAR, RADAR, SONAR, SODAR, ToF, structured light) of the AV 102. The range sensor 525 may be referred to as a depth sensor. The sensor modality fusion engine 425 receives the image 510 and the point cloud 520, and fuses data from the image 510 and the point cloud 520 to generate a combined representation 530 of the vehicle 205 with the door 225 that is at least partially open and/or protruding from the vehicle 205. The combined representation 530 can include both visual data from the image 510 and range (depth) data from the point cloud 520. In some examples, the combined representation 530 is a depth image of the vehicle 205 (e.g, with the door 225), a 3D model of the vehicle 205 (e.g, with the door 225), a 2D boundary (e.g., the bounding boxes 210-215 of FIG. 2A), a 3D boundary (e.g., the bounding boxes 210-215 of FIG. 2B), or a combination thereof.

One benefit of fusion between sensor modalities as illustrated in FIG. 5 is overcoming false positives and/or false negatives caused by shortcomings of individual sensor modalities in unfavorable conditions. For example, if the environment is dark (e.g., nighttime and/or dim illumination), the AV 102 may fail to detect a vehicle 205, door 225, and/or pedestrian 220 using image-based detection, since the image(s) may be underexposed, with contrast is reduced in dark conditions. Similarly, if the environment is bright (e.g., daytime and/or bright illumination), the AV 102 may fail to detect a vehicle 205, door 225, and/or pedestrian 220 using image-based detection, since the image(s) may be overexposed. In some examples, image artifacts (e.g., lens flare, glare, ghosting, lens damage, dead pixels, and/or bokeh) in image(s) may confuse object detection based on image data. Range sensors are generally not as affected by environmental illumination as image sensors, and are not affected by the same types of image artifacts, so fusion between sensor modalities reduces technical issues related to lighting and image artifacts, and allows detection of vehicles 205, doors 225, and/or pedestrians 220 to remain accurate even in different lighting conditions.

In some cases, large vehicles (e.g. fire trucks) may be misclassified as multiple vehicles by the AV 102. In some cases, doors 225 and/or pedestrians 220 of a large vehicle (e.g., fire truck) may be missed by the AV 102 due to smaller relative size of the doors 225 and/or pedestrians 220 compared to the large size of the large vehicle. Range sensors can more clearly discern a large vehicle as being a single unit, and can more clearly discern doors and/or pedestrians as distinct from the rest of the large vehicle. Thus, fusion between sensor modalities reduces technical issues related to large vehicles, and allows detection of vehicles 205, doors 225, and/or pedestrians 220 to remain accurate even in if the vehicles 205 are unusually large.

In some examples, it can be difficult to determine if a door 225 is open or closed in an image because of the angle from which the image sensor(s) of the AV 102 captured the image. For example, in some cases, a seam of a car door can appear similar to the door being partially opened in an image. Range sensors can more clearly discern whether such a door 225 is open or closed regardless of image capture angle. Thus, fusion between sensor modalities reduces such issues and allows detection of vehicles 205, doors 225, and/or pedestrians 220 to remain accurate regardless of image capture angle.

In some examples, one vehicle at least partially occludes another vehicle in an image because of the angle from which the image sensor(s) of the AV 102 captured the image. In some cases, the AV 102 may mistakenly classify an open door from one of the vehicles as belonging to another one of the vehicles. Range sensors can more clearly discern to which vehicle 205 a door 225 belongs, based on the range to the door 225. In some cases, the AV 102 may mis-classify another portion of another vehicle as being a door 225 of a particular vehicle 205. Range sensors can more clearly discern whether such an object is in fact a door 225 of the vehicle 205, based on the range to the door 225. Thus, fusion between sensor modalities reduces technical issues related to occlusions, and allows detection of vehicles 205, doors 225, and/or pedestrians 220 to remain accurate regardless of any occlusions in image data.

On the other hand, on its own, range sensor data can lack context, as it can be difficult to discern which points in a point cloud belong to a vehicle 205, a door 225, a pedestrian 220, or something else. Image data can provide that context. Thus, fusion between sensor modalities reduces technical issues related to lack of context in point cloud data, and can provide context useful for detection of vehicles 205, doors 225, and/or pedestrians 220 in point cloud data.

Some types of range sensors (e.g., RADAR) may provide range data that is more useful to determine velocity of an object (e.g., a door 225) than precise contours of the object. Image data and/or other range data (e.g., LIDAR) can provide the finer-level detail of the object. Thus, for instance, fusion between sensor modalities reduces technical issues related to resolution, and can provide context useful for detection of vehicles 205, doors 225, and/or pedestrians 220 in point cloud data.

FIG. 6 is a conceptual diagram illustrating rerouting of an autonomous vehicle (AV) 102 from a first planned route 615 to a second planned route 625 in response to a change in a bounding box for a vehicle 630 due to detection of a door 640 of the vehicle 630 opening. The vehicle 630 is an example of the vehicle 205. The door 640 is an example of the door 225. An image 655 captured by an image sensor 660 of the AV 102 is illustrated, showing a vehicle 630 (e.g., a van) with a door at least partially open (and/or protruding from the vehicle 630) on the left side of the vehicle 630, and with a pedestrian 635 in the vicinity of the doorway of the vehicle 630 that is associated with the door 640. The pedestrian 635 appears to be exiting the vehicle 630 through the doorway, entering the vehicle 630 through the doorway, and/or lingering in the vicinity of the doorway (e.g., taking things out of the vehicle 630 and/or putting things into the vehicle 630). The pedestrian 635 is an example of the pedestrian 220.

A map 650 of the environment around the AV 102, and the position of the AV 102 within the environment, is illustrated. The map 650 depicts a top-down view of the environment. The environment includes an intersection. The intersection may be a three-way intersection or a four-way intersection. The AV 102 is depicted partway through a left turn across the intersection. Several rounded rectangles are illustrated in the map 650. These rounded rectangles are boundaries (e.g., bounding boxes) for other vehicles in the environment (other than the AV 102). Two boundaries are illustrated for the vehicle 630. A first boundary 610 for the vehicle 630 is illustrated using a dashed line, and represents a boundary for the vehicle 630 before detection of the door 640 opening and/or the pedestrian 635 (e.g., while the door 640 is closed and/or the pedestrian 635 is still in the vehicle 630). A second boundary 620 for the vehicle 630 is illustrated using a thick solid line, and represents a boundary for the vehicle 630 after detection of the door 640 opening and/or the pedestrian 635. The second boundary 620 is larger than the first boundary 610, particularly on the left side of the vehicle 630, because the second boundary 620 includes the door 640 and/or the pedestrian 635. The pedestrian 635 is also illustrated in the map 650, as are several other pedestrians in the environment.

Two planned routes for the AV 102 are illustrated on the map 650. Each of the two planned routes are illustrated using a respective set of two lines. The left-most line of the set of two lines represents the left side of the AV 102, while the right-most line of the set of two lines represents the right side of the AV 102. This way, it is immediately visible in the map 650 if one of the planned routes might intersect with a boundary, indicating a possible collision.

A first planned route 615 for the AV 102 is illustrated using thick dashed lines, and smoothly continues the turn that the AV 102 is partway through. However, the first planned route 615 intersects with the second boundary 620 for the vehicle 630, and thus would likely cause the AV 102 to collide with the vehicle 630 (e.g., at least the door 640) and/or the pedestrian 635. The first planned route 615 may be generated by the AV 102 (e.g., by the route planner 330) while the AV 102 is still using the first boundary 610 for the vehicle 630. The first planned route 615 may be generated by the AV 102 (e.g., by the route planner 330) before detection of the door 640 opening and/or the pedestrian 635 (e.g., while the door 640 is closed and/or the pedestrian 635 is still in the vehicle 630).

A second planned route 625 for the AV 102 is illustrated using thick solid lines, and turns the AV 102 more sharply to the left than the first planned route 615, in order to avoid the second boundary 620 for the vehicle 630. The second planned route 625 for the AV 102 then turns to the right to correct for the sharper left turn, and get closer toward the center of the road. The second planned route 625 does not intersect with the second boundary 620 for the vehicle 630, and thus would prevent the AV 102 from colliding with the vehicle 630 and/or the pedestrian 635. The second planned route 625 may be generated by the AV 102 (e.g., by the route planner 330) while the AV 102 is using the second boundary 620 for the vehicle 630. The second planned route 625 may be generated by the AV 102 (e.g., by the route planner 330) after detection of the door 640 opening and/or the pedestrian 635.

In some cases, the pedestrian 635 is a real, physical pedestrian detected by the AV 102 (e.g., using the pedestrian detector 320). In some cases, the AV 102 does not detect any pedestrian in the vicinity of the doorway of the vehicle 630 corresponding to the door 640, an the pedestrian 635 is instead a shadow pedestrian generated by the AV 102 (e.g., by the pedestrian predictor 325) in the vicinity of the doorway of the vehicle 630 corresponding to the door 640.

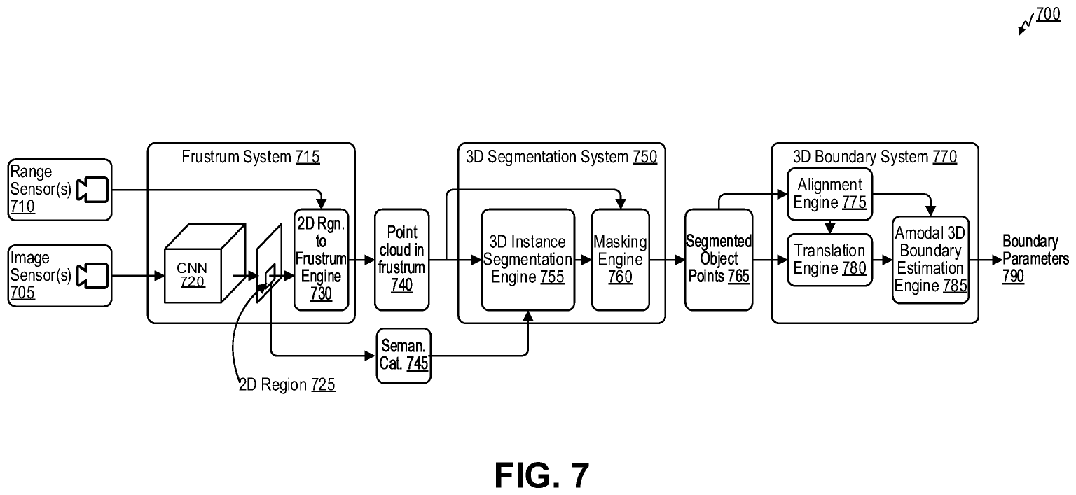

FIG. 7 is a block diagram illustrating a range-based environment analysis system 700. The range-based environment analysis system 700 may be an example of at least a portion of the environment analysis and routing system 300. For instance, the range-based environment analysis system 700 may be an example of the sensor(s) 305, the vehicle detector 310, the door detector 315, the pedestrian detector 320, ML system(s) of the environment analysis and routing system 300, trained ML model(s) of the environment analysis and routing system 300, or a combination thereof. The range-based environment analysis system 700 may be an example of at least a portion of the environment analysis system 400. For instance, the range-based environment analysis system 700 may be an example of the sensor(s) 405, the sensor(s) 415, the analysis engine 470, the object detector(s) 410, the object detector(s) 420, the sensor modality fusion engine 425, the LSTM 430, the FC 435, the ML system(s) 440, the trained ML model(s) 445, or a combination thereof.

The range-based environment analysis system 700 includes image sensor(s) 705 and range sensor(s) 710. The image sensor(s) 705 may be image sensor(s) 705 of camera(s) of the AV 102. The range sensor(s) 710 may include LIDAR sensor(s), RADAR sensor(s), SONAR sensor(s), SODAR sensor(s), ToF sensor(s), structured light sensor(s), or combinations thereof. The range sensor(s) 710 may be referred to as depth sensors. The range-based environment analysis system 700 includes a frustrum system 715 that receives image data from the image sensor(s) 705 and range data from the range sensor(s) 710.

The frustrum system 715 includes a convolutional neural network (CNN) 720 that the frustrum system 715 uses as a 2D object detector to detect an object (e.g., a vehicle 205, a door 225, and/or a pedestrian 220) in the image data from the image sensor(s) 705. The output of the CNN 720 is a 2D region 725 of the image data in which the CNN 720 detected the object. The frustrum system 715 may determine a semantic category 745 of the object using the CNN 720 and/or the 2D region 725. The semantic category 745 may be one of k pre-defined categories (e.g., a vehicle category, a door category, a pedestrian category). The semantic category 745 may be encoded as a vector, such as a one-hot class vector (k-dimensional for the k pre-defined categories).

The frustrum system 715 includes a 2D region to frustrum engine 730 that receives the range data from the range sensor(s) 710, and that projects the 2D region 725 into a 3D frustrum in the direction of one or more vectors from the location of the AV 102 in the environment to the location of the object in the environment. The output of 2D region to frustrum engine 730 is a point cloud within the frustrum 740. Each point cloud within the frustrum 740 may include an intensity, in some examples.

The outputs of frustrum system 715 thus include the point cloud within the frustrum 740 and the semantic category 745. The point cloud within the frustrum 740 and the semantic category 745 may be provided to a 3D interface segmentation engine 755 of a 3D segmentation system 750. The 3D interface segmentation engine 755 provides the point cloud within the frustrum 740 and the semantic category 745 as input(s) to one or more trained ML model(s) that output a respective probability for each point in the point cloud within the frustrum 740. The probability for each point indicates how likely the point is to belong to the object of the semantic category 745. The 3D segmentation system 750 also includes a masking engine 760 that extracts points from the point cloud within the frustrum 740 that are classified as having a high probability (e.g., exceeding a threshold) of belonging to the object. Any other points are deleted, removed, masked away, or otherwise disregarded by the masking engine 760. The masking engine 760, and by extension the 3D segmentation system 750, thus outputs a set of segmented object points 765.

The segmented object points 765 are provided to an alignment engine 775 and/or a translation engine 780 of a 3D boundary system 770. The translation engine 780 normalizes the coordinates of the segmented object points 765 to increase translational invariance and/or translational symmetry of the segmented object points 765. In some examples, the translation engine 780 transforms the coordinates of the segmented object points 765 into local coordinates around a centroid of the segmented object points 765.

The 3D boundary system 770 provides the segmented object points 765 as input(s) to one or more trained ML model(s) of the alignment engine 775 that predict the true center of the complete object, even if part of the object is not represented in the segmented object points 765 (e.g., if part of the object is not depicted in the image data from the image sensor(s) 705 and/or represented in the range data from the range sensor(s) 710). The alignment engine 775 can use its trained ML model(s) to predict center residuals from the center of the segmented object points 765 output by the masking engine 760 to the real center of the object. The alignment engine 775 may provide the center residuals to the translation engine 780 to supervise and/or guide the translation of the coordinates of the segmented object points 765.

The 3D boundary system 770 includes an amodal 3D boundary estimation engine 785 that estimates a 3D boundary for the object. The object's 3D boundary may be a 3D bounding box. The object's 3D boundary may be amodal. The object's 3D boundary may be a boundary for the entire object, even if part of the object is not depicted in the image data from the image sensor(s) 705 and/or represented in the range data from the range sensor(s) 710. In some examples, the 3D boundary system 770 provides predicted center of the object from the alignment engine 775, and/or the translated points from the translation engine 780, as input(s) to one or more trained ML model(s) of the amodal 3D boundary estimation engine 785 that estimates the boundary for the object. The 3D boundary system 770 may parametrize the 3D boundary into boundary parameters 790. For instance, if the 3D boundary is a 3D bounding box (e.g., the bounding boxes 210-215 of FIG. 2B), the 3D boundary system 770 may parametrize the 3D boundary into boundary parameters 790 including coordinates (x, y, and/or z) for the center of the 3D bounding box, the size (height, width, and/or length) of the 3D bounding box, and/or an orientation (roll, pitch, and/or yaw) of the 3D bounding box.

Various elements of the range-based environment analysis system 700 include, or can include, ML system(s) and/or trained ML model(s), for instance including the CNN 720, the 2D region to frustrum engine 730, the 3D instance segmentation engine 755, the alignment engine 775, the translation engine 780, and/or the amodal 3D boundary estimation engine 785. The respective ML system(s) and/or trained ML model(s) for these elements may include, for instance, one or more neural networks (NNs) (e.g., the NN 800 of FIG. 8), one or more convolutional neural networks (CNNs), one or more trained time delay neural networks (TDNNs), one or more deep networks, one or more autoencoders, one or more deep belief nets (DBNs), one or more recurrent neural networks (RNNs), one or more generative adversarial networks (GANs), one or more other types of neural networks, one or more trained support vector machines (SVMs), one or more trained random forests (RFs), or combinations thereof. Examples of the respective ML system(s) and/or trained ML model(s) for these elements may include the NN 800, ML system(s) of the environment analysis and routing system 300, trained ML model(s) of the environment analysis and routing system 300, the analysis engine 470, the object detector(s) 410, the object detector(s) 420, the sensor modality fusion engine 425, the LSTM 430, the FC 435, the ML system(s) 440, the trained ML model(s) 445, or a combination thereof.

FIG. 8 is a block diagram illustrating an example of a neural network (NN) 800 that can be used is for environment analysis. The neural network 800 can include any type of deep network, such as a convolutional neural network (CNN), an autoencoder, a deep belief net (DBN), a Recurrent Neural Network (RNN), a Generative Adversarial Networks (GAN), and/or other type of neural network.

In some examples, the NN 800 may be an example of the vehicle detector 310, the door detector 315, the pedestrian detector 320, the pedestrian predictor 325, the route planner 330, ML system(s) of the environment analysis and routing system 300, trained ML model(s) of the environment analysis and routing system 300, or a combination thereof. In some examples, the NN 800 may be an example of the analysis engine 470, the object detector(s) 410, the object detector(s) 420, the sensor modality fusion engine 425, the LSTM 430, the FC 435, the ML system(s) 440, the trained ML model(s) 445, or a combination thereof. In some examples, the NN 800 may be an example of the ML system(s) and/or trained ML model(s) of the CNN 720, the 2D region to frustrum engine 730, the 3D instance segmentation engine 755, the alignment engine 775, the translation engine 780, and/or the amodal 3D boundary estimation engine 785, or a combination thereof.

According to an illustrative example, the NN 800 can be used by the environment analysis and routing system 300, the environment analysis system 400, and/or the range-based environment analysis system 700 to detect a vehicle 205, a door 225, a pedestrian 220, or a combination thereof. According to another illustrative example, the NN 800 can be used by the environment analysis and routing system 300, the environment analysis system 400, and/or the range-based environment analysis system 700 to generate a boundary (e.g., a bounding box) for a vehicle 205, a door 225, a pedestrian 220, or a combination thereof. According to another illustrative example, the NN 800 can be used by the pedestrian predictor 325 of the environment analysis and routing system 300 to generate a shadow pedestrian based on detection of a door 225. According to another illustrative example, the NN 800 can be used by the route planner 330 of the environment analysis and routing system 300 to generate a route 340 to avoid a vehicle 205, a door 225, a pedestrian 220, and/or a boundary (e.g., bounding box) that includes one or more of the previously-listed objects.

An input layer 810 of the neural network 800 includes input data. The input data of the input layer 810 can include data representing feature(s) corresponding to sensor data captured by one or more sensor(s) of the AV 102, such as the sensor system 1 104, the sensor system 2 106, the sensor system 3 108, the sensor(s) 305, the sensor(s) 405, the sensor(s) 415, the image sensor 515, the range sensor 525, the image sensor 660, the image sensor(s) 705, the range sensor(s) 710, the input device(s) 1245, any other sensors described herein, or a combination thereof. In some examples, the input data of the input layer 810 includes metadata associated with the sensor data. The input data of the input layer 810 can include data representing feature(s) corresponding to detection of an object (e.g., a vehicle 205, a door 225, and/or a pedestrian 220) in image data (e.g., image(s) and/or video(s)) and/or range data (e.g., point cloud(s)). In some examples, the input data of the input layer 810 includes information about the AV 102, such as the pose of the AV 102, the speed of the AV 102, the velocity of the AV 102, the direction of the AV 102, the acceleration of the AV 102, or a combination thereof. The pose of the AV 102 can include the location (e.g., latitude, longitude, altitude/elevation) and/or orientation (e.g., pitch, roll, yaw) of the vehicle 205.

The neural network 800 includes multiple hidden layers 812A, 812B, through 812N. The hidden layers 812A, 812B, through 812N include “N” number of hidden layers, where “N” is an integer greater than or equal to one. The number of hidden layers can be made to include as many layers as needed for the given application. The neural network 800 further includes an output layer 814 that provides an output resulting from the processing performed by the hidden layers 812A, 812B, through 812N.

In some examples, the output layer 814 can provide object detection, recognition, and/or classification, as in the vehicle detector 310, the door detector 315, the pedestrian detector 320, the analysis engine 470, the object detector(s) 410, the object detector(s) 420, the sensor modality fusion engine 425, the LSTM 430, the FC 435, the ML system(s) 440, the trained ML model(s) 445, the CNN 720, or a combination thereof. In some examples, the output layer 814 can provide a pose, boundary, and/or path of a shadow pedestrian, as in the pedestrian predictor 325. In some examples, the output layer 814 can provide a route 340 that avoids objects (e.g., vehicles 205, doors 225, pedestrians 220 (real or shadow)) and/or that avoids boundaries including one or more objects, as in the route planner 330. In some examples, the output layer 814 can provide a boundary (e.g., bounding box 210, bounding box 215, first boundary 610, second boundary 620, boundary defined by boundary parameters 790) based on detection of an object, as in the CNN 720, the 2D region to frustrum engine 730, the 3D instance segmentation engine 755, the alignment engine 775, the translation engine 780, and/or the amodal 3D boundary estimation engine 785, or a combination thereof. In some examples, the output layer 814 can provide a semantic category (e.g., vehicle category, left side door category, right side door category, rear door category, pedestrian category, left door classification head 450, right door classification head 455, rear door classification head 460, face classification head 465, semantic category 745), parameters for a shadow pedestrian (e.g., location, orientation, path, speed, velocity), parameters for a route 340 (e.g., coordinates of waypoints and/or checkpoints, curvature), parameters for a boundary (e.g., boundary parameters 790), and/or intermediate parameters to be provided to other trained ML model(s) to produce one of the previously-listed outputs.

The neural network 800 is a multi-layer neural network of interconnected filters. Each filter can be trained to learn a feature representative of the input data. Information associated with the filters is shared among the different layers and each layer retains information as information is processed. In some cases, the neural network 800 can include a feed-forward network, in which case there are no feedback connections where outputs of the network are fed back into itself. In some cases, the network 800 can include a recurrent neural network, which can have loops that allow information to be carried across nodes while reading in input.

In some cases, information can be exchanged between the layers through node-to-node interconnections between the various layers. In some cases, the network can include a convolutional neural network, which may not link every node in one layer to every other node in the next layer. In networks where information is exchanged between layers, nodes of the input layer 810 can activate a set of nodes in the first hidden layer 812A. For example, as shown, each of the input nodes of the input layer 810 can be connected to each of the nodes of the first hidden layer 812A. The nodes of a hidden layer can transform the information of each input node by applying activation functions (e.g., filters) to this information. The information derived from the transformation can then be passed to and can activate the nodes of the next hidden layer 812B, which can perform their own designated functions. Example functions include convolutional functions, downscaling, upscaling, data transformation, and/or any other suitable functions. The output of the hidden layer 812B can then activate nodes of the next hidden layer, and so on. The output of the last hidden layer 812N can activate one or more nodes of the output layer 814, which provides a processed output image. In some cases, while nodes (e.g., node 816) in the neural network 800 are shown as having multiple output lines, a node has a single output and all lines shown as being output from a node represent the same output value.

In some cases, each node or interconnection between nodes can have a weight that is a set of parameters derived from the training of the neural network 800. For example, an interconnection between nodes can represent a piece of information learned about the interconnected nodes. The interconnection can have a tunable numeric weight that can be tuned (e.g., based on a training dataset), allowing the neural network 800 to be adaptive to inputs and able to learn as more and more data is processed.

The neural network 800 is pre-trained to process the features from the data in the input layer 810 using the different hidden layers 812A, 812B, through 812N in order to provide the output through the output layer 814.

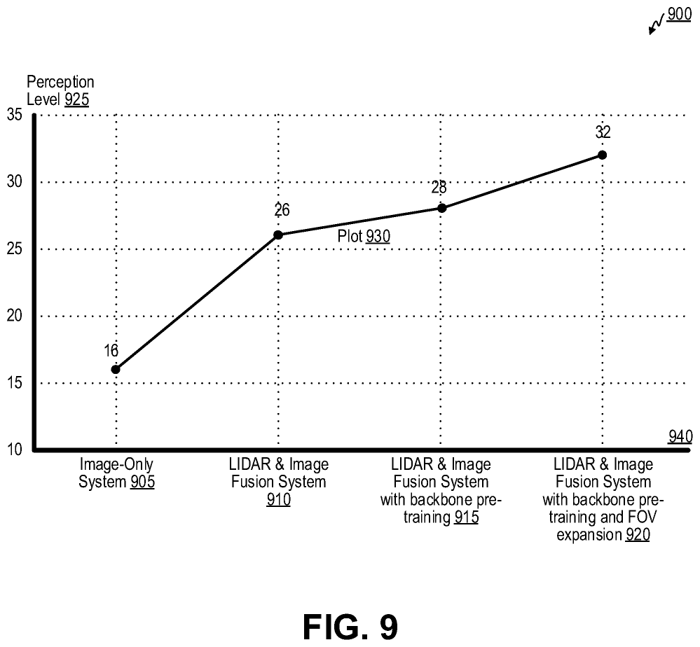

FIG. 9 is a graph 900 illustrating respective perception levels for different types of environment analysis systems. The graph 900 includes a vertical axis identifying perception level 925. The perception level 925, in the graph 900 of FIG. 9, represents a count of number of issues related to doors that AVs 102 experienced in a given time period using each of the types of environment analysis system. The graph 900 includes a horizontal axis 940 that identifies four different types of environment analysis systems. The graph 900 includes a plot 930 identifying perception levels for each of the four different types of environment analysis systems. The first of the four different types of environment analysis systems listed along the horizontal axis 940 is an image-only system 905, which only uses image data from image sensor(s) for its object detections, and which has a perception level of 16 according to the plot 930. The second of the four different types of environment analysis systems listed along the horizontal axis 940 is a LIDAR and image fusion system 910, which uses both image data from image sensor(s) and range data from LIDAR sensor(s) for its object detections, and which has a perception level of 26 according to the plot 930. Thus, use of LIDAR and image fusion provides a perception benefit over use of only image data.

The third of the four different types of environment analysis systems listed along the horizontal axis 940 is a LIDAR and image fusion system with backbone pre-training 915. This third system uses both image data from image sensor(s) and range data from LIDAR sensor(s) for its object detections. This third system separately trains the ML model(s) for its image sensor backbone and the ML model(s) for its LIDAR sensor backbone, before then jointly training the fused image and range data combination. This third system has a perception level of 28 according to the plot 930. Thus, training of the image and LIDAR backbones separately and also jointly provides a perception benefit over training these only jointly.

The fourth of the four different types of environment analysis systems listed along the horizontal axis 940 is a LIDAR and image fusion system with backbone pre-training and field of view (FOV) expansion 920. This fourth system uses both image data from image sensor(s) and range data from LIDAR sensor(s) for its object detections, and trains the backbones for these sensors separately and jointly like the third system. This fourth system also uses expanded FOV, for instance by obtaining data from more sensors, no longer cropping data that was cropped for the first three environment analysis systems, using wide-angle lenses, or a combination thereof. This fourth system has a perception level of 32 according to the plot 930. Thus, expansion of FOV provides a perception benefit over reduced FOVs.

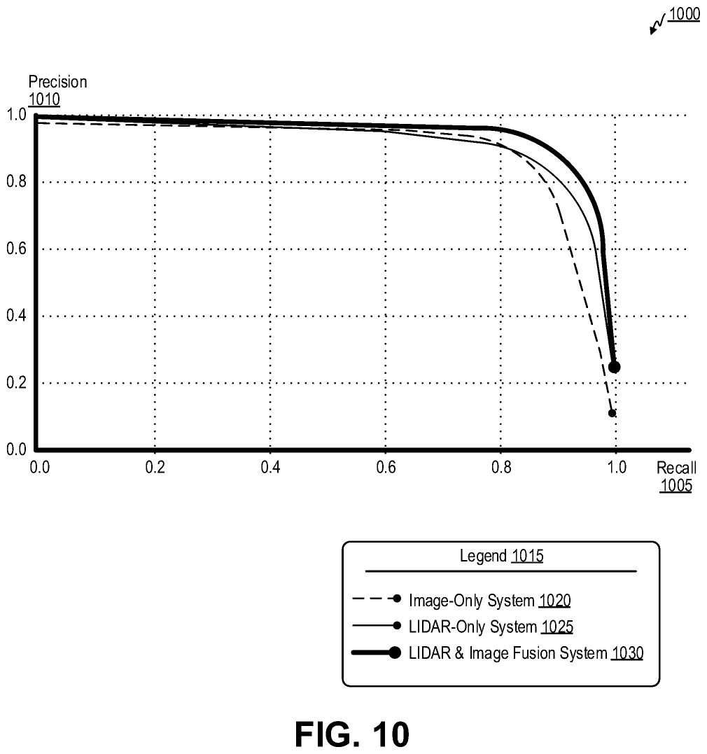

FIG. 10 is a graph 1000 illustrating respective precision-recall curves for different types of environment analysis systems. The graph 1000 includes a vertical axis identifying precision 1010, ranging from zero to one. The graph 1000 includes a horizontal axis identifying recall 1005, ranging from zero to one. The graph 1000 includes a legend 1015, which identifies three precision-recall curves for three different types of environment analysis systems.

The first of the three different types of environment analysis systems listed in the legend 1015 is an image-only system 1020, which only uses image data from image sensor(s) for its object detections. The precision-recall curve for the image-only system 1020 is illustrated using a thin dashed line.

The second of the three different types of environment analysis systems listed in the legend 1015 is a LIDAR-only system 1025, which only uses range data from LIDAR sensor(s) for its object detections. The precision-recall curve for the LIDAR-only system 1025 is illustrated using a thin solid line.

The third of the three different types of environment analysis systems listed in the legend 1015 is a LIDAR and image fusion system 1030, which uses both image data from image sensor(s) and range data from LIDAR sensor(s) for its object detections. The precision-recall curve for the LIDAR and image fusion system 1030 is illustrated using a thick solid line. The precision-recall curve for the LIDAR and image fusion system 1030 shows that the LIDAR and image fusion system 1030 achieves the best detection rate, and the fewest false positives, of the three different types of environment analysis systems listed in the legend 1015.

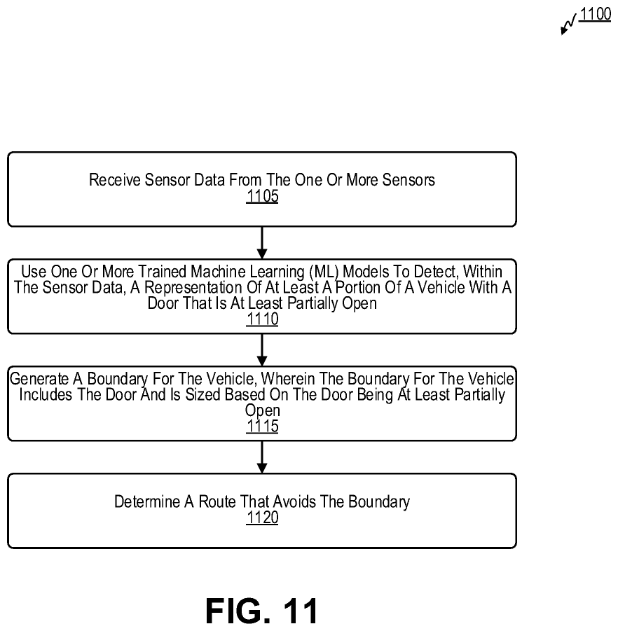

FIG. 11 is a flow diagram illustrating a process 1100 for environmental analysis. The process 1100 for environmental analysis is performed by an analysis system. The analysis system includes, for instance, the AV 102, the local computing device 110, the sensor systems 104-108, the client computing device 170, the data center 150, the data management platform 152, the AI/ML platform 154, the simulation platform 156, the remote assistant platform 158, the ridesharing platform 160, the environment analysis and routing system 300, the sensor(s) 305, the vehicle detector 310, the door detector 315, the pedestrian detector 320, the pedestrian predictor 325, the route planner 330, the vehicle steering, propulsion, and/or braking system(s) 335, ML system(s) of the environment analysis and routing system 300, trained ML model(s) of the environment analysis and routing system 300, the sensor(s) 405, the sensor(s) 415, the analysis engine 470, the object detector(s) 410, the object detector(s) 420, the sensor modality fusion engine 425, the LSTM 430, the FC 435, the ML system(s) 440, the trained ML model(s) 445, the image sensor 515, the range sensor 525, the image sensor 660, the range-based environment analysis system 700, the image sensor(s) 705, the range sensor(s) 710, the frustrum system 715, the 3D segmentation system 750, the 3D boundary system 770, the neural network 800, the image-only system 905, the LIDAR and image fusion system 910, the LIDAR and image fusion system with backbone pre-training 915, the LIDAR and image fusion system with backbone pre-training and field of view (FOV) expansion 920, the image-only system 1020, the LIDAR-only system 1025, the LIDAR and image fusion system 1030, the computing system 1200, the processor 1210, or a combination thereof.

At operation 1105, the analysis system is configured to, and can, receive sensor data from the one or more sensors. Examples of the one or more sensors include the sensor system 1 104, the sensor system 2 106, the sensor system 3 108, the sensor(s) 305, the sensor(s) 405, the sensor(s) 415, the image sensor 515, the range sensor 525, the image sensor 660, the image sensor(s) 705, the range sensor(s) 710, the input device(s) 1245, any other sensors or sensors systems described herein, or a combination thereof. Examples of the sensor data include the image 510, the point cloud 520, the image 655, sensor data from any of the previously-listed examples of sensors, any other sensor data described herein, or a combination thereof.

In some examples, the analysis system includes at least one sensor connector that couples the analysis system (and/or one or more processors thereof) to the one or more sensors. In some examples, the analysis system receives the sensor data from the one or more sensors using the sensor connector. In some examples, the analysis system receives the sensor data from the sensor connector when the analysis system receives the sensor data from the one or more sensors. In some examples, the sensors are coupled to a housing of the analysis system. The housing may be a housing of a vehicle, such as a housing of the AV 102.

At operation 1110, the analysis system is configured to, and can, use one or more trained machine learning (ML) models to detect, within the sensor data, a representation of at least a portion of a vehicle with a door that is at least partially open. In some examples, the one or more trained ML models detect the door being at least partially open by detecting that the door is protruding from the vehicle. In some examples, the analysis system detects the representation using the vehicle detector 310, the door detector 315, the pedestrian detector 320, ML system(s) of the environment analysis and routing system 300, trained ML model(s) of the environment analysis and routing system 300, the analysis engine 470, the object detector(s) 410, the object detector(s) 420, the sensor modality fusion engine 425, the LSTM 430, the FC 435, the ML system(s) 440, the trained ML model(s) 445, the range-based environment analysis system 700, the image sensor(s) 705, the range sensor(s) 710, the frustrum system 715, the 3D segmentation system 750, the 3D boundary system 770, the neural network 800, or a combination thereof. Examples of the one or more ML models include the ML system(s) of the environment analysis and routing system 300, the trained ML model(s) of the environment analysis and routing system 300, the ML system(s) 440, the trained ML model(s) 445, the ML system(s) of the range-based environment analysis system 700, the trained ML model(s) of the range-based environment analysis system 700, the NN 800, or a combination thereof.

In some examples, the vehicle detected in operation 1110 is a car, truck, automobile, van, or another land vehicle. In some examples, the vehicle detected in operation 1110 is a boat, a ship, a yacht, a submarine, or another aquatic vehicle. In some examples, the vehicle detected in operation 1110 is drone, a plane, a helicopter, a hovercraft, or another aerial vehicle. In some examples, the vehicle detected in operation 1110 is an AV 102.

In some examples, the one or more sensors include an image sensor. The sensor data includes an image captured by the image sensor. The representation of at least the portion of the vehicle with the door that is at least partially open (and/or protruding from the vehicle) is part of the image. Examples of the image sensor include the include the sensor system 1 104, the sensor system 2 106, the sensor system 3 108, the sensor(s) 305, the sensor(s) 405, the sensor(s) 415, the image sensor 515, the image sensor 660, the image sensor(s) 705, the input device(s) 1245, any other image sensors or image sensor systems described herein, or a combination thereof. Examples of the image include the image 510, the image 655, sensor data from any of the previously-listed examples of image sensors, any other images or image data described herein, or a combination thereof.

In some examples, the one or more sensors include a range sensor. The sensor data includes a point cloud generated based on range data captured by the range sensor. The representation of at least the portion of the vehicle with the door that is at least partially open (and/or protruding from the vehicle) is part of the point cloud. The range sensor may include, for example, a LIDAR sensor, a RADAR sensor, a SONAR sensor, a SODAR sensor, a ToF sensor, a structured light sensor, or a combination thereof. Examples of the range sensor include the include the sensor system 1 104, the sensor system 2 106, the sensor system 3 108, the sensor(s) 305, the sensor(s) 405, the sensor(s) 415, the range sensor 525, the range sensor(s) 710, the input device(s) 1245, any other range sensors or range sensor systems described herein, or a combination thereof. Examples of the range data include the point cloud 520, sensor data from any of the previously-listed examples of sensors, any other sensor data described herein, or a combination thereof.

At operation 1115, the analysis system is configured to, and can, generate a boundary for the vehicle. The boundary for the vehicle includes the door and is sized based on the door being at least partially open (and/or protruding from the vehicle). Examples of a boundary for the vehicle include the bounding box 210, the bounding box 215, the first boundary 610, the second boundary 620, the boundary defined by boundary parameters 790, another bounding box for a vehicle described herein, another boundary for a vehicle described herein, or a combination thereof. Examples of a boundary for the vehicle and the door include the bounding box 215, the second boundary 620, the boundary defined by boundary parameters 790, another bounding box for a vehicle and its door described herein, another boundary for a vehicle and its door described herein, or a combination thereof. Generating the boundary may be performed using the vehicle detector 310, the door detector 315, the pedestrian detector 320, the pedestrian predictor 325, the analysis engine 470, the object detector(s) 410, the object detector(s) 420, the sensor modality fusion engine 425, the LSTM 430, the FC 435, the ML system(s) 440, the trained ML model(s) 445, the range-based environment analysis system 700, the image sensor(s) 705, the range sensor(s) 710, the frustrum system 715, the 3D segmentation system 750, the 3D boundary system 770, the neural network 800, or a combination thereof.

In some examples, the analysis system is configured to, and can, determine that the door is on a first side of the vehicle. The boundary for the vehicle includes an expanded area along the first side of the vehicle. The expanded area includes at least a portion of the door. The first side of the vehicle can be one of multiple sides of the vehicle, for instance one of 4 sides (e.g., of a quadrilateral such as a rectangle) or one of 6 sides (e.g., of a quadrilateral prism such as a rectangular prism).

In some examples, the analysis system is configured to, and can, use the one or more trained ML models to detect, within the sensor data, a representation of a pedestrian having used a doorway of the vehicle corresponding to the door, for instance using the pedestrian detector 320. In some examples, the boundary for the vehicle includes the pedestrian and is sized based on the pedestrian. Examples of the pedestrian include the pedestrian 220 and the pedestrian 635. Examples of a boundary that includes the vehicle and the pedestrian include the bounding box 215 and the second boundary 620 for the vehicle 630.

In some examples, the analysis system is configured to, and can, determine that the pedestrian is on a first side of the vehicle. The boundary for the vehicle includes an expanded area along the first side of the vehicle. The expanded area includes at least a portion of the pedestrian. The first side of the vehicle can be one of multiple sides of the vehicle, for instance one of 4 sides (e.g., of a quadrilateral such as a rectangle) or one of 6 sides (e.g., of a quadrilateral prism such as a rectangular prism).

In some examples, the analysis system is configured to, and can, generate, based on the door being at least partially open, a predicted pedestrian position associated with use of a doorway of the vehicle corresponding to the door, for instance using the pedestrian predictor 325. In some examples, the boundary for the vehicle includes the predicted pedestrian position and is sized based on the predicted pedestrian position. The predicted pedestrian position may be a position of a shadow pedestrian generated using the pedestrian predictor 325. The pedestrian 220 and the pedestrian 635 can be examples of the shadow pedestrian. Examples of a boundary that includes the vehicle and the pedestrian include the bounding box 215 and the second boundary 620 for the vehicle 630.

In some examples, the analysis system is configured to, and can, generate, based on the door being at least partially open, a predicted pedestrian path associated with use of a doorway of the vehicle corresponding to the door, for instance using the pedestrian predictor 325. In some examples, the boundary for the vehicle includes the predicted pedestrian path and is sized based on the predicted pedestrian path. In some examples, the predicted pedestrian path may be a path of a shadow pedestrian generated using the pedestrian predictor 325. The pedestrian 220 and the pedestrian 635 can be examples of the shadow pedestrian. In some examples, the predicted pedestrian path may be a predicted path of a real pedestrian detected using the pedestrian detector 320.

In some examples, the analysis system is configured to, and can, determine that the shadow pedestrian is on a first side of the vehicle. The boundary for the vehicle includes an expanded area along the first side of the vehicle. The expanded area includes at least a portion of the shadow pedestrian. The first side of the vehicle can be one of multiple sides of the vehicle, for instance one of 4 sides (e.g., of a quadrilateral such as a rectangle) or one of 6 sides (e.g., of a quadrilateral prism such as a rectangular prism).

In some examples, the analysis system is configured to, and can, determine that the predicted pedestrian path is on a first side of the vehicle. The boundary for the vehicle includes an expanded area along the first side of the vehicle. The expanded area includes at least a portion of the predicted pedestrian path. The first side of the vehicle can be one of multiple sides of the vehicle, for instance one of 4 sides (e.g., of a quadrilateral such as a rectangle) or one of 6 sides (e.g., of a quadrilateral prism such as a rectangular prism).

In some examples, the analysis system is configured to, and can, receive secondary sensor data from one or more secondary sensors. Examples of the one or more secondary sensors include any of the examples of the one or more sensors of operation 1105. Examples of the secondary sensor data include any of the examples of the sensor data of operation 1105. In some examples, the analysis system is configured to, and can, use one or more secondary trained ML models to detect, within the secondary sensor data, a second representation of at least a second portion of the vehicle with the door that is at least partially open. Examples of the one or more secondary trained ML models include any of the examples of the one or more trained ML models of operation 1110. In some examples, the one or more secondary trained ML models are distinct from the one or more trained ML models. Generating the boundary for the vehicle is based on the representation of at least the portion of the vehicle with the door that is at least partially open and on the second representation of at least the portion of the vehicle with the door that is at least partially open. In some examples, the one or more sensors have a different sensor modality than the one or more secondary sensors. In an illustrative example, the one or more sensors may be image sensors, while the one or more secondary sensors may be range sensors. In another illustrative example, the one or more sensors may be range sensors, while the one or more secondary sensors may be image sensors. Examples of generating the boundary for the vehicle based on the sensor data from the one or more sensors and the secondary sensor data from the one or more secondary sensors are illustrated at least in FIGS. 3, 4, and 7.

In some example, a shape of the boundary includes a two-dimensional (2D) polygon, for instance as illustrated in FIG. 2A or FIG. 6. For example, the shape of the boundary can include a rectangle, a triangle, a square, a trapezoid, a parallelogram, a quadrilateral, a pentagon, a hexagon, another polygon, a portion thereof, or a combination thereof. In some examples, the a shape of the boundary includes a round two-dimensional (2D) shape, such as a circle, a semicircle, an ellipse, another rounded 2D shape, a portion thereof, or a combination thereof. In some examples, a shape of the boundary includes a three-dimensional (3D) polyhedron, for instance as illustrated in FIG. 2B. For example, the shape of the boundary can include a rectangular prism, a cube, a pyramid, a triangular prism, a prism of a another polygon, a tetrahedron, another polyhedron, a portion thereof, or a combination thereof. In some examples, the boundary for the vehicle can include a round three-dimensional (3D) shape, such as a sphere, an ellipsoid, a cone, a cylinder, another rounded 3D shape, a portion thereof, or a combination thereof.

At operation 1120, the analysis system is configured to, and can, determine a route that avoids the boundary. Examples of the route include the route 340, the first planned route 615 (which avoids the first boundary 610 for the vehicle 630 with the door 640 closed), the second planned route 625 (which avoids the second boundary 620 for the vehicle 630 with the door 640 open), another route described herein, or a combination thereof. Determining the route may be performed using the route planner 330.

In some examples, determining the route that avoids the boundary includes modifying a previously-set route to avoid the boundary. In some examples, the previously-set route may have been configured to intersect with (e.g., collide with) the boundary before this modification. An example of such a modification includes the modification from the first planned route 615 for the AV 102 to the second planned route 625 for the AV 102 in FIG. 6, to avoid the second boundary 620 for the vehicle 630.

In some examples, the route avoids the boundary at least in part by including a path around the boundary. For instance, the first planned route 615 includes a path around the first boundary 610 for the vehicle 630, and the second planned route 625 includes a path around the second boundary 620 for the vehicle 630. In some examples, the route avoids the boundary at least in part by including a stop (e.g., of the AV 102) to avoid intersecting with the boundary (e.g., before an intersection (e.g., collision) with the boundary). The stop may be a trigger indication that causes the analysis system to use its brakes to slow down and/or stop. In some examples, the route avoids the boundary by at least a threshold distance.

In some examples, the analysis system is configured to, and can, update the one or more trained ML models at least in part by training the one or more trained ML models based on the representation of at least the portion of the vehicle with the door that is at least partially open. In some examples, the analysis system is configured to, and can, update the one or more trained ML models at least in part by training the one or more trained ML models based on feedback received from a user interface, the feedback associated with the representation of at least the portion of the vehicle with the door that is at least partially open.

In some examples, the analysis system is a vehicle. In some examples, the analysis system is a car, truck, automobile, van, or another land vehicle. In some examples, the analysis system is a boat, a ship, a yacht, a submarine, or another aquatic vehicle. In some examples, the analysis system is drone, a plane, a helicopter, a hovercraft, or another aerial vehicle. In some examples, the analysis system is the AV 102. In some examples, the analysis system includes the sensors of operation 1105.

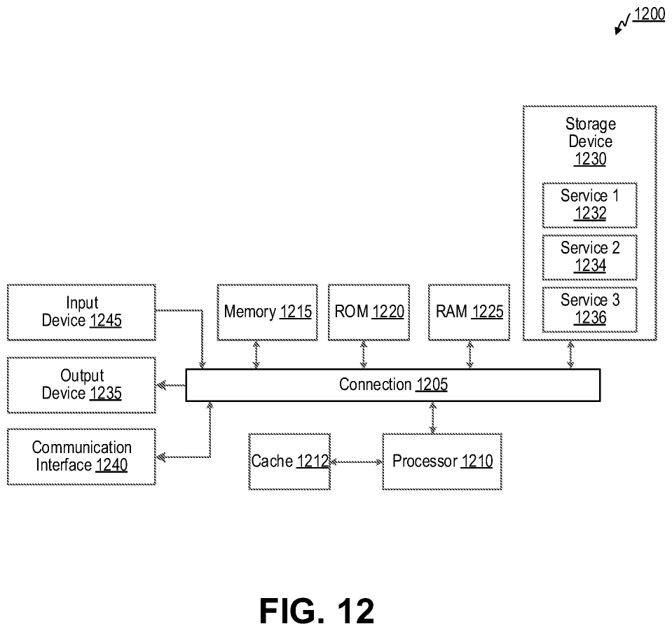

FIG. 12 shows an example of computing system 1200, which can be for example any computing device making up the AV 102, the local computing device 110, the data center 150, the client computing device 170, the environment analysis and routing system 300, the environment analysis system 400, the range-based environment analysis system 700, the neural network 800, the image-only system 905, the LIDAR and image fusion system 910, the LIDAR and image fusion system with backbone pre-training 915, the LIDAR and image fusion system with backbone pre-training and field of view (FOV) expansion 920, the image-only system 1020, the LIDAR-only system 1025, or any component thereof in which the components of the system are in communication with each other using connection 1205. Connection 1205 can be a physical connection via a bus, or a direct connection into processor 1210, such as in a chipset architecture. Connection 1205 can also be a virtual connection, networked connection, or logical connection.

In some embodiments, computing system 1200 is a distributed system in which the functions described in this disclosure can be distributed within a datacenter, multiple data centers, a peer network, etc. In some embodiments, one or more of the described system components represents many such components each performing some or all of the function for which the component is described. In some embodiments, the components can be physical or virtual devices.

Example system 1200 includes at least one processing unit (CPU or processor) 1210 and connection 1205 that couples various system components including system memory 1215, such as read-only memory (ROM) 1220 and random access memory (RAM) 1225 to processor 1210. Computing system 1200 can include a cache of high-speed memory 1212 connected directly with, in close proximity to, or integrated as part of processor 1210.

Processor 1210 can include any general purpose processor and a hardware service or software service, such as services 1232, 1234, and 1236 stored in storage device 1230, configured to control processor 1210 as well as a special-purpose processor where software instructions are incorporated into the actual processor design. Processor 1210 may essentially be a completely self-contained computing system, containing multiple cores or processors, a bus, memory controller, cache, etc. A multi-core processor may be symmetric or asymmetric.

To enable user interaction, computing system 1200 includes an input device 1245, which can represent any number of input mechanisms, such as a microphone for speech, a touch-sensitive screen for gesture or graphical input, keyboard, mouse, motion input, speech, etc. Computing system 1200 can also include output device 1235, which can be one or more of a number of output mechanisms known to those of skill in the art. In some instances, multimodal systems can enable a user to provide multiple types of input/output to communicate with computing system 1200. Computing system 1200 can include communications interface 1240, which can generally govern and manage the user input and system output. The communication interface may perform or facilitate receipt and/or transmission wired or wireless communications via wired and/or wireless transceivers, including those making use of an audio jack/plug, a microphone jack/plug, a universal serial bus (USB) port/plug, an Apple® Lightning® port/plug, an Ethernet port/plug, a fiber optic port/plug, a proprietary wired port/plug, a BLUETOOTH® wireless signal transfer, a BLUETOOTH® low energy (BLE) wireless signal transfer, an IBEACON® wireless signal transfer, a radio-frequency identification (RFID) wireless signal transfer, near-field communications (NFC) wireless signal transfer, dedicated short range communication (DSRC) wireless signal transfer, 802.11 Wi-Fi wireless signal transfer, wireless local area network (WLAN) signal transfer, Visible Light Communication (VLC), Worldwide Interoperability for Microwave Access (WiMAX), Infrared (IR) communication wireless signal transfer, Public Switched Telephone Network (PSTN) signal transfer, Integrated Services Digital Network (ISDN) signal transfer, 3G/4G/5G/LTE cellular data network wireless signal transfer, ad-hoc network signal transfer, radio wave signal transfer, microwave signal transfer, infrared signal transfer, visible light signal transfer, ultraviolet light signal transfer, wireless signal transfer along the electromagnetic spectrum, or some combination thereof. The communications interface 1240 may also include one or more Global Navigation Satellite System (GNSS) receivers or transceivers that are used to determine a location of the computing system 1200 based on receipt of one or more signals from one or more satellites associated with one or more GNSS systems. GNSS systems include, but are not limited to, the US-based Global Positioning System (GPS), the Russia-based Global Navigation Satellite System (GLONASS), the China-based BeiDou Navigation Satellite System (BDS), and the Europe-based Galileo GNSS. There is no restriction on operating on any particular hardware arrangement, and therefore the basic features here may easily be substituted for improved hardware or firmware arrangements as they are developed.

Storage device 1230 can be a non-volatile and/or non-transitory and/or computer-readable memory device and can be a hard disk or other types of computer readable media which can store data that are accessible by a computer, such as magnetic cassettes, flash memory cards, solid state memory devices, digital versatile disks, cartridges, a floppy disk, a flexible disk, a hard disk, magnetic tape, a magnetic strip/stripe, any other magnetic storage medium, flash memory, memristor memory, any other solid-state memory, a compact disc read only memory (CD-ROM) optical disc, a rewritable compact disc (CD) optical disc, digital video disk (DVD) optical disc, a blu-ray disc (BDD) optical disc, a holographic optical disk, another optical medium, a secure digital (SD) card, a micro secure digital (microSD) card, a Memory Stick® card, a smartcard chip, a EMV chip, a subscriber identity module (SIM) card, a mini/micro/nano/pico SIM card, another integrated circuit (IC) chip/card, random access memory (RAM), static RAM (SRAM), dynamic RAM (DRAM), read-only memory (ROM), programmable read-only memory (PROM), erasable programmable read-only memory (EPROM), electrically erasable programmable read-only memory (EEPROM), flash EPROM (FLASHEPROM), cache memory (L1/L2/L3/L4/L5/L#), resistive random-access memory (RRAM/ReRAM), phase change memory (PCM), spin transfer torque RAM (STT-RAM), another memory chip or cartridge, and/or a combination thereof.

The storage device 1230 can include software services, servers, services, etc., that when the code that defines such software is executed by the processor 1210, it causes the system to perform a function. In some embodiments, a hardware service that performs a particular function can include the software component stored in a computer-readable medium in connection with the necessary hardware components, such as processor 1210, connection 1205, output device 1235, etc., to carry out the function.

For clarity of explanation, in some instances, the present technology may be presented as including individual functional blocks including functional blocks comprising devices, device components, steps or routines in a method embodied in software, or combinations of hardware and software.

Any of the steps, operations, functions, or processes described herein may be performed or implemented by a combination of hardware and software services or services, alone or in combination with other devices. In some embodiments, a service can be software that resides in memory of a client device and/or one or more servers of a content management system and perform one or more functions when a processor executes the software associated with the service. In some embodiments, a service is a program or a collection of programs that carry out a specific function. In some embodiments, a service can be considered a server. The memory can be a non-transitory computer-readable medium.

In some embodiments, the computer-readable storage devices, mediums, and memories can include a cable or wireless signal containing a bit stream and the like. However, when mentioned, non-transitory computer-readable storage media expressly exclude media such as energy, carrier signals, electromagnetic waves, and signals per se.

Methods according to the above-described examples can be implemented using computer-executable instructions that are stored or otherwise available from computer-readable media. Such instructions can comprise, for example, instructions and data which cause or otherwise configure a general purpose computer, special purpose computer, or special purpose processing device to perform a certain function or group of functions. Portions of computer resources used can be accessible over a network. The executable computer instructions may be, for example, binaries, intermediate format instructions such as assembly language, firmware, or source code. Examples of computer-readable media that may be used to store instructions, information used, and/or information created during methods according to described examples include magnetic or optical disks, solid-state memory devices, flash memory, USB devices provided with non-volatile memory, networked storage devices, and so on.

Devices implementing methods according to these disclosures can comprise hardware, firmware and/or software, and can take any of a variety of form factors. Typical examples of such form factors include servers, laptops, smartphones, small form factor personal computers, personal digital assistants, and so on. The functionality described herein also can be embodied in peripherals or add-in cards. Such functionality can also be implemented on a circuit board among different chips or different processes executing in a single device, by way of further example.

The instructions, media for conveying such instructions, computing resources for executing them, and other structures for supporting such computing resources are means for providing the functions described in these disclosures.

Although a variety of examples and other information was used to explain aspects within the scope of the appended claims, no limitation of the claims should be implied based on particular features or arrangements in such examples, as one of ordinary skill would be able to use these examples to derive a wide variety of implementations. Further and although some subject matter may have been described in language specific to examples of structural features and/or method steps, it is to be understood that the subject matter defined in the appended claims is not necessarily limited to these described features or acts. For example, such functionality can be distributed differently or performed in components other than those identified herein. Rather, the described features and steps are disclosed as examples of components of systems and methods within the scope of the appended claims.

As described herein, one aspect of the present technology is the gathering and use of data available from various sources to improve quality and experience. The present disclosure contemplates that in some instances, this gathered data may include personal information. The present disclosure contemplates that the entities involved with such personal information respect and value privacy policies and practices.

What is claimed is:

1. A system for environmental analysis, the system comprising:
a sensor connector configured to couple one or more processors to one or more sensors that are coupled to a housing;
one or more memory units storing instructions; and
the one or more processors within the housing, wherein execution of the instructions by the one or more processors causes the one or more processors to:
receive sensor data from the one or more sensors;
use one or more trained machine learning (ML) models to detect, within the sensor data, a representation of at least a portion of a vehicle with a door that is at least partially open;
generate a boundary for the vehicle, wherein the boundary for the vehicle includes the door and is sized based on the door being at least partially open; and
determine a route that avoids the boundary.

2. The system of claim 1, wherein the housing is at least part of a second vehicle, and wherein the route is for the second vehicle and includes a position of the second vehicle.

3. The system of claim 2, wherein execution of the instructions by the one or more processors causes the one or more processors to:
cause the second vehicle to autonomously traverse the route.

4. The system of claim 1, wherein execution of the instructions by the one or more processors causes the one or more processors to:
determine that the door is on a first side of the vehicle, wherein the boundary for the vehicle includes an expanded area along the first side of the vehicle, wherein the expanded area includes at least a portion of the door.

5. The system of claim 1, wherein the one or more sensors include an image sensor, wherein the sensor data includes an image captured by the image sensor, wherein the representation of at least the portion of the vehicle with the door that is at least partially open is part of the image.

6. The system of claim 1, wherein the one or more sensors include a range sensor, wherein the sensor data includes a point cloud generated based on range data captured by the range sensor, wherein the representation of at least the portion of the vehicle with the door that is at least partially open is part of the point cloud.

7. The system of claim 6, wherein the range sensor is a light detection and ranging (LIDAR) sensor.

8. The system of claim 1, wherein execution of the instructions by the one or more processors causes the one or more processors to:
use the one or more trained ML models to detect, within the sensor data, a representation of a pedestrian having used a doorway of the vehicle corresponding to the door, wherein the boundary for the vehicle includes the pedestrian and is sized based on the pedestrian.

9. The system of claim 8, wherein execution of the instructions by the one or more processors causes the one or more processors to:
determine that the pedestrian is on a first side of the vehicle, wherein the boundary for the vehicle includes an expanded area along the first side of the vehicle, wherein the expanded area includes at least a portion of the pedestrian.

10. The system of claim 1, wherein execution of the instructions by the one or more processors causes the one or more processors to:
generate, based on the door being at least partially open, a predicted pedestrian position associated with use of a doorway of the vehicle corresponding to the door, wherein the boundary for the vehicle includes the predicted pedestrian position and is sized based on the predicted pedestrian position.

11. The system of claim 1, wherein execution of the instructions by the one or more processors causes the one or more processors to:
generate, based on the door being at least partially open, a predicted pedestrian path associated with use of a doorway of the vehicle corresponding to the door, wherein the boundary for the vehicle includes the predicted pedestrian path and is sized based on the predicted pedestrian path.

12. The system of claim 1, wherein execution of the instructions by the one or more processors causes the one or more processors to:
receive secondary sensor data from one or more secondary sensors;
use one or more secondary trained ML models to detect, within the secondary sensor data, a second representation of at least a second portion of the vehicle with the door that is at least partially open, wherein generating the boundary for the vehicle is based on the representation of at least the portion of the vehicle with the door that is at least partially open and on the second representation of at least the portion of the vehicle with the door that is at least partially open.

13. The system of claim 1, wherein determining the route that avoids the boundary includes modifying a previously-set route to avoid the boundary.

14. The system of claim 1, wherein the route avoids the boundary at least in part by including a path around the boundary.

15. The system of claim 1, wherein the route avoids the boundary at least in part by including a stop to avoid intersecting with the boundary.

16. The system of claim 1, wherein the route avoids the boundary by at least a threshold distance.

17. The system of claim 1, wherein a shape of the boundary includes a two-dimensional (2D) polygon.

18. The system of claim 1, wherein a shape of the boundary includes a three-dimensional (3D) polyhedron.

19. The system of claim 1, wherein execution of the instructions by the one or more processors causes the one or more processors to:
update the one or more trained ML models at least in part by training the one or more trained ML models based on the representation of at least the portion of the vehicle with the door that is at least partially open.

20. A method for environmental analysis, the method comprising:
receiving sensor data from one or more sensors;
using one or more trained machine learning (ML) models to detect, within the sensor data, a representation of at least a portion of a vehicle with a door that is at least partially open;
generating a boundary for the vehicle, wherein the boundary for the vehicle includes the door and is sized based on the door being at least partially open; and
determining a route that avoids the boundary.
